(19) United States
(12) Patent Application Publication
(10) Pub. No.: US 2002/0026507 A1
(43) Pub. Date: Feb. 28, 2002

(54) Browser proxy client application service provider (ASP) interface

(76) Inventors: Brent C. Sears, West Point, UT (US); Johannes F. Van Rooyen, Salt Lake City, UT (US)

Correspondence Address: Hal D. Baird, PATE PIERCE & BAIRD, Bank One Tower, Suite 900, 50 West Broadway, Salt Lake City, UT, 84101, US

(21) Appl. No.: 09/764,973

(22) Filed: Jan. 18, 2001

Related U.S. Application Data
(63) Continuation of application No. 09/650,806, filed on Aug. 30, 2000.

(51) Int. Cl. G06F 15/173; G06F 15/16

(52) U.S. Cl. 709/224; 709/203

(57) ABSTRACT

A system for serving applications, including legacy applications, from an application server to browser clients. The system is capable of serving any application to any client using any browser, removing the need for upgrading client application software and the need for installation of additional software bits on the client. Preferably, the system includes an application server configured to execute an application thereon and communicate the user interface portion of the application through a web server to a browser proxy client for publication directly into a browser. The system may also incorporate a caching module for selectively capturing data from the user interface corresponding to the execution of the application on the application server. The system may also provide auditing, monitoring, reviewing, and reporting computer data communicated corresponding to the execution of the served applications. The browser proxy client is also capable of publishing the user interfaces of many executing applications to the browsers of many users, in a one to many or many to many relationship. The caching module also may render the captured data inaccessible to users. The system may also include an audit module for providing to an independent agent data reflecting computer usage corresponding to the execution of the application for audit in accordance with a classification system that identifies data for audit. The system may also include a reporting module for providing instant alerts and periodic reports constituting usage summaries and regarding access to data to a reviewing authority. The system may also include an archive module for creating and maintaining records of computer usage, Internet access, or data access.

### BACKGROUND

1. Related Inventions

This application is a Continuation of and claims priority to co-pending U.S. patent application Ser. No. 09/650,806, filed on Aug. 30, 2000, which is incorporated herein by reference.

2. The Field of the Invention

The invention relates generally to computer systems, and more specifically to methods and apparatus for providing a browser proxy client application service provider (ASP) interface (“BPC/ASPI”) that enables the serving of applications across networks into the browsers of users without installation of client “bit sets.” The BPC/ASPI allows legacy and non-browser-based applications to be served from an application service provider (ASP) or across a network to a user's browser.

### Background

The computer age has advanced from analog computers having hard-wired program instructions up through programmable digital computers, and now highly networked programmable digital computers sharing information and applications across the world. With the advent of the computer as a business tool, nearly every profession now requires access to a computer in order to properly complete the daily routine of a job. Applications (computer programs) have grown in size and number in order to address numerous needs in numerous industries. Those applications can collect information, store information, retrieve information, send and receive communications and information, create graphic or text files, and so forth.

As networking has become more pervasive in the computer arts, internetworks have become prominent. In general, an internetwork is a network that includes more than one network, independent from one another, connected by a router. The ultimate internetwork today is often referred to as the Internet. The Internet includes a confederation of virtually any computer in the world having access to an Internet Service Provider (ISP). ISPs manage the routing and serving functions required in order to transfer packets of information between a set of subscribers, and a backbone computer network that has access to “the Internet.”

Thus, the Internet has placed in the hands of every individual user of a computer, through an ISP the ability to access any other computer that has been connected to cooperate in the Internet.

Early computer services, referring to computer services delivered by servers over telecommunications networks such as the telephone system, relied on paid subscribers who dialed a specific phone number, in order to access a server by way of telephone communication lines. Although the hardware suite remains substantially the same, software architectures have changed. For example, the browser is an application on a computer for accessing an ISP, and the Internet beyond. A browser is an application executing on the processor of a computer in order to manage the uploading and downloading of menus, selections, content, and the like. Thus, originally, a user dialed up a phone number, the computer connected to another computer, and the two computers communicated through a communications application built upon some proprietary or standardized protocol. Thus, companies like Compuserve, GE Net, and America Online, became prominent as an industry through subscribers who dialed up to get access to computer resources.

Today, dial-up systems still exist. Dial-up systems are still popular among individual users. However, many enterprises (companies, organizations, foundations, etc.) may rely on a central server to provide access to the Internet for all users on a local area network or wide area network served by the enterprise server owned by that company. Meanwhile, the browser has become available as a suitable alternative to proprietary, esoteric, difficult, temperamental, access communication packages.

Regarding content, the Internet has brought a further substantial change. In addition to the browser being a ubiquitous application easily launched, and easily navigated by the most unsophisticated users, the value of placing content in communication with the Internet has become big business. “Company.com names” abound. Old line industries have developed “web sites” to host graphic illustrations of their products, their catalogs, their services, their personnel, and any other information that may be useful. Research sites abound, services sites abound, providing all types of information and assistance. Much of the Internet content is supported by advertising dollars. That is, banner ads, framed ads, and many types of visual media are placed periodically or permanently in the view of a user who is accessing services from a service provider of Internet content. In summary, the Internet has become a free-for-all information exchange.

Mass adoption of the Internet and broad use of Internet browsers have encouraged software developers to use the Internet to deliver applications to users. The protocol used on the Internet, HTTP, and the associated language for describing the look of Web pages, HTML, were designed primarily for publishing static material. User interaction is limited to facilitate the publication of information to large numbers of users, while giving the appearance of simultaneous interactive access.

Several options currently exist for centrally delivering applications across network connections to distributed users. These options include the traditional client/server architecture, distributed computing, and server-based computing. The foregoing options differ in the processing model used, as well as the type of hardware required. A client/server architecture centers processing around local execution using “fat,” (i.e. computationally powerful) client devices and “fat,” (i.e. high bandwidth) expensive pipes that can accommodate high-speed transport of bandwidth-intensive applications. In distributed computing, components are dynamically downloaded from the network to the client for execution, also requiring a “fat” or computationally powerful client for processing. In contrast, server-based architectures withhold 100 percent of the application execution on the server, enabling the use of almost any device as a client whether “fat” or “thin.”

The traditional client/server and distributed computing models may be expensive and complicated to support and administer. The traditional model may also limit the ability of an enterprise to add new users, provide high-level application performance, ensure security of information, and take advantage of new, “thin” client devices. Enterprises are seeking new methods and approaches that may deliver expanded application reach, high performance, security, and cost-effectiveness.

Many applications, however, require a level of interaction that is beyond the capabilities of HTTP and HTML. While attempts have been made to extend HTFP) and HTML to deliver full interactivity, the results have either compromised the application's performance or reduced functionality.

Application server computing overcomes several of the foregoing problems by delivering application richness and interactivity of client/server applications over the Internet, while ensuring a “thin” client footprint. This approach has also substantially reduced, but not completely eliminated, the need to rebuild the user interface with HTML, Java or other customized programming. Even the “thin” client model, requires the building of a client “bit set” or program designed to enable the serving of applications to different computer platforms (e.g. windows-based systems, Unix-based systems, and the like). Accordingly, for each application to be web published or served, “someone” must design, code and support a client software application for each different platform in existence. Moreover, users and administrators of such systems are faced with the time and expense of installing and maintaining applications on multiple types of machines (client “bit sets”).

Another problem is that many legacy applications that are still in use are not supported under the “thin” client model, or are not browser-enabled. Such legacy applications are, therefore, currently not capable of being served across the Internet into the browser of a user.

Two additional significant problems that pertain to Internet content have arisen for enterprise computer system management. In fact, enterprise management in companies and organizations is facing a new epidemic. Rather than sick days, users at their desks in companies around the world are suffering “Internet brown out.” Productivity of individuals drops as they become involved in non-work-related Internet sites. The Internet is now capable of delivering content to satisfy almost any curiosity. Vacation planning, off-track betting, shopping, news, and even humor are now so ubiquitous on the Internet as to capture the attention of workers and consume a substantial fraction of the work day. Frequent reports in the national media list pornography and investment tracking as the number one and number two most visited web sites during business hours. Accordingly, in spite of the fantastic array of valuable information available to individuals and companies in conducting their personal and commercial lives, distractions are available to undercut productivity of individuals having access to the Internet. As computers have become ubiquitous and Internet access has become ubiquitous, costs have declined substantially. However, the enterprise cost to the bottom line is increasing with distraction and consumption of workers' time.

Along with the waste of time, is a generalized waste of resources. Companies pay for telephone lines, for high speed communications lines, for additional computers, for additional software, for maintenance personnel, additional employees, and the like. All of these resources are typically dedicated to maintaining the fastest, most productive, most valuable Internet communication system practicable for conducting the business of a company. To the extent that those resources are diverted, additional money is spent to purchase additional capacity in hardware, software, bandwidth, and the like, without those resources actually being directed ultimately to the productivity of the enterprise. Thus, bandwidth and hardware are consumed largely for personal use in individual companies. Moreover, bandwidth is being consumed in all telecommunications lines used for communications in the Internet. Someone pays for every line laid. Accordingly, someone is paying for wasted bandwidth. Bottom line management of enterprises has identified this diversion of resources as significant but not easily measurable or avoidable.

The second major difficulty with the Internet arises in several contexts. The problem is access to inappropriate content. Inappropriate content may be circumscribed by any set of rules, including without limitation moral, financial, criminal, regulatory, corporate policy, and personal or family policies. Rules in homes and companies may be as simple as a limitation on the hours that a child may spend in front of a television monitor or a computer monitor, as compared with time spent sleeping, executing chores, or doing homework. Likewise, in a company, rules may proscribe access to certain information, such as financial information of a company, if one has no “need to know.” In the defense industry., for example, information is classified, not only according to its sensitivity with respect to national security, but also with respect to the need of an individual in their specific job role to have access to information. Similarly, in any enterprise (government agency, company, family, etc.) access may be status based according to one's need for certain information. For example, a company does not need every employee to have access to travel agents providing information on Cancun or Hawaiian vacation spots.

As browsers become more powerful and more important in their role as the primary engine to access information on the Internet, companies begin relying on information distributed across numerous servers on site or off site. Accordingly, certain financial information, personnel information, management information, decision information, product information, and the like may be managed in various databases throughout the world by any company of substantial size. Access to information becomes a major management task. Thus, sensitive information may be inappropriate for access by any random employee. Nevertheless, such information may be critical to the efficient functioning of another individual or organization within a company.

The bounds of desire for regulation of inappropriate access are not yet defined. Companies find numerous situations in which restriction of access to selected information can more easily manage difficulties. For example, access to inappropriate chat sites may be a waste of time, or provide access to inappropriate content. For parents, such access by children is a major concern. The trump card in the frightening onslaught of Internet content is pornographic sites. Meanwhile, the ubiquitous and innocuous electronic mail system has been used for stalking. Stalkers have actually stalked and harassed individuals with impunity for years. Cyber stalking is a major criminal investigation area for police forces.

Meanwhile, the epidomy of inappropriate content, is pornographic content available to individuals in companies at their workstations, or available to children at home. Also, unwanted access to pornographic sites, as a result of search engines picking up meta data from various sites, may provide unwanted content presented to a user, as a result of a simple search for selected information.

Filtering can provide certain protections. However, filtering is universally decried due to the massive restrictions that the oversimplified filtering algorithms impose on the legitimate use on the Internet by individuals. For example, some filters simply filter automatically any site from a foreign country. For international companies, such filtering is ludicrous. Other sites or ISPs, or individual applications, may filter selected words. Again, the English language, and presumably other languages, have hosts of words that have hosts of meanings depending almost entirely on context. Sometimes even spellings and pronunciations are identical, and only the context makes the difference. Thus, legitimate research into articles on breast cancer is typically filtered by the clumsy filter engines that are currently available.

Another difficulty is the desire of all content providers to capture as many viewers as possible, and maintain the viewers' interest in the content providers' web sites. Accordingly, some web sites have linked themselves to other web sites, or have obscured the exit controls such that the hasty exit is virtually impossible from an inappropriate site. Thus, inappropriate content presented without request, but in response to some meta data or word that triggered such a connection, may actually consume several minutes of an individual's time searching for a method to exit the site. Also, linked sites may simply send a user on a URL “goose chase” trying to come to the end of the linked string of sites.

Currently available filters are incapable of auditing access or reporting access time, content, or the like to inappropriate content. The value of auditing content, is the prospect of enforcement of policies by agents responsible for such enforcement. For example, if a parent or a family has established rules for Internet content and access, but has no mechanism for auditing adherence to the rules, the rules have no meaning. “Can't manage what you can't monitor.”

In an industrial or commercial environment, company policies on sexual harassment, use of time on the job, content access, and the like cannot be enforced if they cannot be monitored. Most insidiously, if a company has an employee guilty of gross sexual harassment; inappropriate access to pornographic content; wasting time doing online shopping; newspaper reading, or vacation planning; any other inappropriate access to sites; or overuse of company time, a record must be built in order to administer any discipline. Even knowing that one has been monitored, and reprimanded for inappropriate access on the Internet, is enough to resolve many problems. However, problems with persistent violators of policies or law, regardless of the rule or the agency enforcing the rule, cannot be dealt with absent a clear record of evidence setting forth the case against the violator of a policy or law. Moreover, such a system must be robust enough that defeat is neither simple nor easy. Ideally, defeat of such a system should be virtually impossible. To the extent that the auditing function were defeated, the auditing system should leave a trail identifying that it has been defeated in order that corrective action may be taken.

What is needed is a new method and apparatus for governing Internet access. Particularly, what is needed is a system capable of operating at the access speed of a user, for auditing the content accessed by a user. Such a system also needs to be capable of operating under the emerging application server model. Preferably, such a system would enable the serving of applications (both legacy and web-enabled) into end users' browsers without the need for installation of client “bit sets” or programs on the end users' computers. Such a system would also preferably enable the auditing of applications and of user accessed content from and to multiple client browsers without interruption of the security system in use between the client and the secure application server facility.

### BRIEF SUMMARY AND OBJECTS OF THE INVENTION

In view of the foregoing, it is a primary object of the present invention to provide a method and apparatus for auditing, reporting, tracking, and even filtering or blocking Internet access by users.

It is another object of the invention to provide a system for capturing content accessed by users, and storing that content for auditing and reporting purposes.

It is also an object of the invention to provide a system capable of operating under the emerging application server model that enables the serving of applications (both legacy and web-enabled) into end users' browsers running on any type of platform without the need for installation of client “bit sets” or programs on the end users' computers.

It is a further object of the invention to provide a system that enables the auditing of user accessed content within the application server model without interruption of the security systems in use.

It is also an object to provide a viewing system that is based primarily on visual content of web pages accessed, rather than extensive reading of cryptic electronic messages encoded in text.

Also, it is an object of the invention to provide a system that operates in virtually real time to capture content accessed by any user.

It is an object of the invention to create records that are stored by a third party that cannot be deleted from a computer of a user, even if the user has sufficient sophistication to empty the Internet cache corresponding to the browser hosted on the user's computer.

It is another object to provide a recording mechanism for reviewing, viewing, organizing, alerting, and the like, as needed.

It is another object to provide a recording mechanism for auditing, reviewing, viewing, organizing, reporting, alerting, and the like, as needed.

It is another object of the invention to provide an archiving system for selectively storing records for corrective action or to augment an alert or reporting, without having to consume inordinate resources for storage of such archived content.

Consistent with the foregoing objects, and in accordance with the invention as embodied and broadly described herein, an apparatus and method are disclosed in one embodiment of the present invention as including an application server configured to execute an application thereon and communicate the user interface portion of the application through a web server to a browser proxy client for publication directly into a browser. The browser proxy client is also capable of handling the application server interface of many executing applications to the browsers of many users, in a one to many relationship. The system may also incorporate a caching module for selectively capturing data and images from the user interface corresponding to the execution of the application on the application server.

The system is also capable of handling the application server interface of legacy applications that execute only on legacy servers into the browser of a user or into the browsers of many users substantially simultaneously.

Also, a system may include a manager module for managing the content received. The manager module may include, or may cooperate with, an auditor module available for screening files containing content captured based on the Internet access of a user. In selected embodiments, a system in accordance with the invention may include a database. The database may include principal records, and also may include supplementary records. This system may include archives as integral, simply marked for archiving, and thus not ever destroyed, or may include archive records that are saved in a separate database, or in a different record set from principle records. In certain embodiments, an apparatus and method in accordance with the invention may include a reporting module or a reviewing module.

The reporting or reviewing modules may be responsible to alert a management person, such as an auditor or manager of an acute problem with Internet access. Likewise, the reporting or reviewing module may provide some reporting system or documentation bringing attention to abnormalities or inappropriate patterns in Internet access. Moreover, in certain selected embodiments, a reviewing module may actually provide a very high speed presentation of substantially every image that has been presented to a user from Internet access. Also, automatic pattern recognition or analysis of content, including analysis of meta data, text data, and other indicia of the type or class of site involved, may be provided by a reporting or reviewing engine. Necessarily, in such embodiments, the capture module must be programmed to save any appropriate access data that may be useful in maintaining a policy or procedure, and in auditing compliance therewith.

In selected embodiments, a filter module may actually develop filter rules based on the output of the auditing module. That is, after judgment has been exercised by an auditor, an engine may be developed to enforce auditing rules against offensive sites, or against offending conduct, or against inappropriate patterns of activity, according to the learning of such a filter module. Automated analysis of page text, HTML text, e-mail text, or XML text may aid and speed this categorizing of content and in applying rules.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram of one architecture for a hardware suite suitable for implementing an apparatus in accordance with the present invention;

FIG. 2 is a schematic block diagram of various configurations of users and servers accessing the Internet through ISPs, along with implementation schemes for implementing apparatus and methods in accordance with the invention;

FIG. 3 is a schematic block diagram of data structures suitable for implementing at least one embodiment of an apparatus and method in accordance with the present invention;

FIGS. 4-5 illustrate schematic block diagrams of the data structures further detailing the functions and modules illustrated in FIG. 3;

FIG. 6 is a schematic block diagram of selected data structures identifying the types and content of data stored in a database in accordance with the invention;

FIG. 7 is a schematic block diagram of several alternative embodiments of software architectures and hardware architectures for implementing an apparatus and method in accordance with the invention, regardless of the specific hardware architecture for connection to the Internet;

FIG. 8 is a schematic block diagram of a process for capturing, auditing, evaluating, and archiving data in accordance with the invention;

FIG. 9 is a schematic block diagram of a method for implementing one or more embodiments of the invention;

FIG. 10 is a schematic block diagram of one embodiment of a capture step of FIG. 9;

FIG. 11 is a schematic block diagram of one embodiment of an audit step of FIG. 9;

FIG. 12 is a schematic block diagram of a process for searching out and downloading the contents of caches used for downloading Internet content to an individual user, and thus of interest to execution of an apparatus and method in accordance with the invention;

FIG. 13 is a schematic block diagram of one embodiment of an architecture for maintaining an object-oriented database, and illustrating a directory services approach to such an object-oriented database, including selected options for objects associated with various levels of the hierarchical database structure;

FIG. 14 is a schematic block diagram of one embodiment of a software architecture and hardware architecture for implementing an apparatus and method in accordance with the invention; and

FIG. 15 is an elevation view of browser screen output from the embodiment of a client platform software and hardware architecture of FIG. 14.

### DETAILED DESCRIPTION OF THE PREFERRED EMBODIMENTS

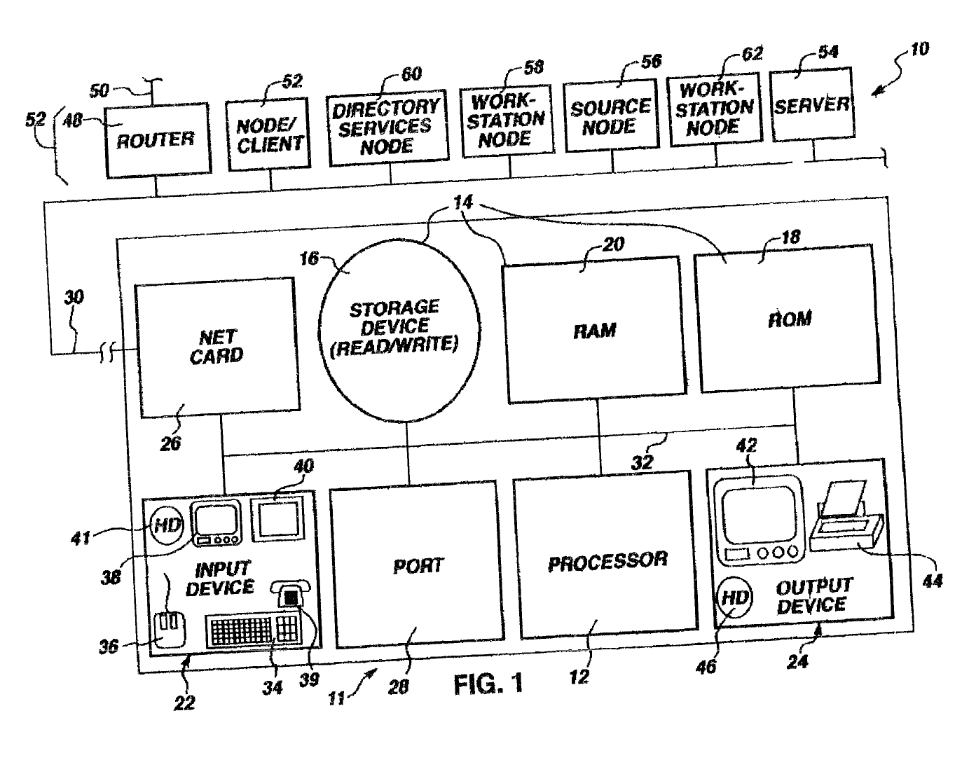

It will be readily understood that the components of the present invention, as generally described and illustrated in the Figures herein, could be arranged and designed in a wide variety of different configurations. Thus, the following more detailed description of the embodiments of the system and method of the present invention, as represented in FIGS. 1 through 15, is not intended to limit the scope of the invention, as claimed, but it is merely representative of the presently preferred embodiments of the invention.

The presently preferred embodiments of the invention will be best understood by reference to the drawings, wherein like parts are designated by like numerals throughout.

Those of ordinary skill in the art will, of course, appreciate that various modifications to the details illustrated in the schematic diagrams of FIGS. 1-13 may easily be made without departing from the essential characteristics of the invention. Thus, the following description is intended only as an example, and simply illustrates one presently preferred embodiment consistent with the invention as claimed herein.

Referring now to FIG. 1, an apparatus 10 may include a node 11 (client 11, computer 11) containing a processor 12 or CPU 12. The CPU 12 may be operably connected to a memory device 14. A memory device 14 may include one or more devices such as a hard drive 16 or non-volatile storage device 16, a read-only memory 18 (ROM) and a random-access (and usually volatile) memory 20 (RAM).

The apparatus 10 may include an input device 22 for receiving inputs from a user or another device. Similarly, an output device 24 may be provided within the node 11, or accessible within the apparatus 10. A network card 26 (interface card) or port 28 may be provided for connecting to outside devices, such as the network 30.

Internally, a bus 32 (system bus 32) may operably interconnect the processor 12, memory devices 14, input devices 22, output devices 24, network card 26 and port 28. The bus 32 may be thought of as a data carrier. As such, the bus 32 may be embodied in numerous configurations. Wire, fiber optic line, wireless electromagnetic communications by visible light, infrared, and radio frequencies may likewise be implemented as appropriate for the bus 32 and the network 30.

Input devices 22 may include one or more physical embodiments. For example, a keyboard 34 may be used for interaction with the user, as may a mouse 36. A touch screen 38, a telephone 39, or simply a telephone line 39, may be used for communication with other devices, with a user, or the like.

Similarly, a scanner 40 may be used to receive graphical inputs which may or may not be translated to other character formats. A hard drive 41 or other memory device 14 may be used as an input device whether resident within the node 11 or some other node 52 (e.g., 52a, 52b, etc.) on the network 30, or from another network 50.

Output devices 24 may likewise include one or more physical hardware units. For example, in general, the port 28 may be used to accept inputs and send outputs from the node 11. Nevertheless, a monitor 42 may provide outputs to a user for feedback during a process, or for assisting two-way communication between the processor 12 and a user. A printer 44 or a hard drive 46 may be used for outputting information as output devices 24.

In general, a network 30 to which a node 11 connects may, in turn, be connected through a router 48 to another network 50. In general, two nodes 11, 52 may be on a network 30, adjoining networks 30, 50, or may be separated by multiple routers 48 and multiple networks 50 as individual nodes 11, 52 on an internetwork. The individual nodes 52 may have various communication capabilities.

In certain embodiments, a minimum of logical capability may be available in any node 52. Note that any of the individual nodes 52 may be referred to, as may all together, as a node 52 or nodes 52.

A network 30 may include one or more servers 54. Servers may be used to manage, store, communicate, transfer, access, update, and the like, any number of files for a network 30. Typically, a server 54 may be accessed by all nodes 11, 52 on a network 30. Nevertheless, other special functions, including communications, applications, and the like may be implemented by an individual server 54 or multiple servers 54.

In general, a node 11 may need to communicate over a network 30 with a server 54, a router 48, or nodes 52. Similarly, a node 11 may need to communicate over another network (50) in an internetwork connection with some remote node 52. Likewise, individual components of the apparatus 10 may need to communicate data with one another. A communication link may exist, in general, between any pair of devices or components.

By the expression “nodes” 52 is meant any one or all of the nodes 48,52,54,56,58, 60, 62, 11. Thus, any one of the nodes 52 may include any or all of the component parts illustrated in the node 11.

The directory services node 60 provides the directory services as known in the art. Accordingly, the directory services node 60 hosts the software and data structures required for providing directory services to the nodes 52 in the network 30 and may do so for other nodes 52 in other networks 50.

The directory services node 60 may typically be a server 54 in a network. However, it may be installed in any node 52. To support directory services, a directory services node 52 may typically include a network card 26 for connecting to the network 30, a processor 12 for processing software commands in the directory services executables, a memory device 20 for operational memory as well as a non-volatile storage device 16 such as a hard drive 16. Typically, an input device 22 and an output device 24 are provided for user interaction with the directory services node 60.

In general, any number of workstation nodes 58,62 may exist in a network 30, within some practical limit. Any network 30, 50 may be part of, and connect to the Internet 72.

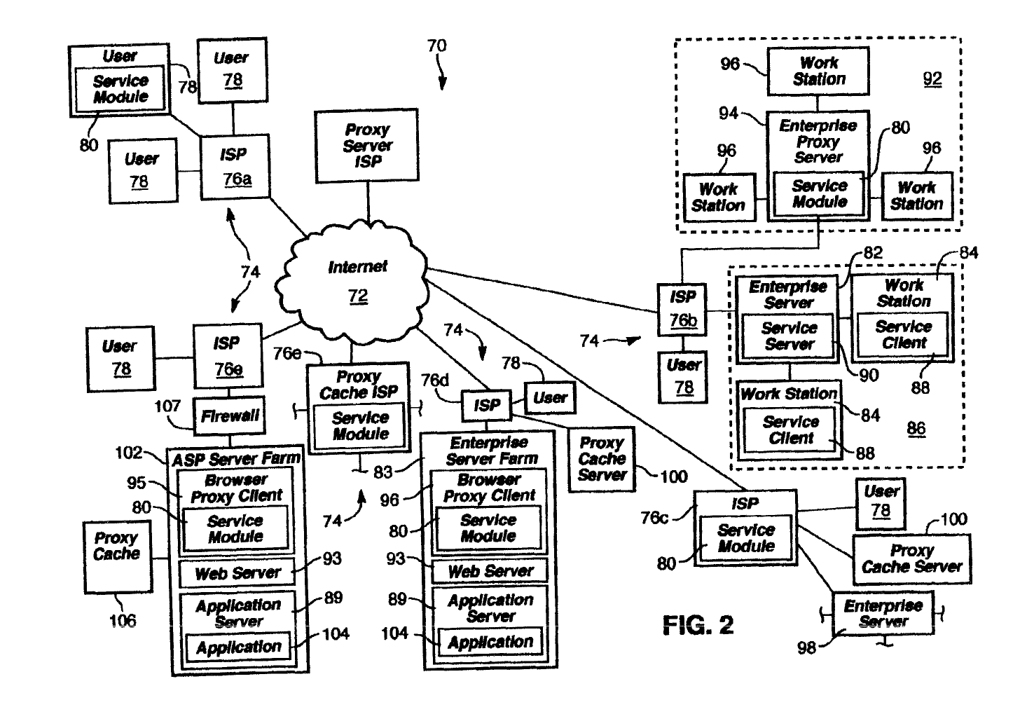

Referring now to FIG. 2 while continuing to refer to FIG. 1, a system 70 may include the Internet 72, or be connected to the Internet 72. In general, various other networks 74 may connect through Internet Service Providers 76 (“ISPs”) to the Internet 72, and ultimately to each other. The reference numerals 76 include various individual ISP entities 76a-76f. In general, any of the individual ISPs 76 may connect to a plurality of individual users 78. Individual users 78 may host on a computer 11, a service module 80 or via its browser, without additional software or “bit set” access the proxy client 95 and service module 80.

In one alternative embodiment, an enterprise server 82 may connect to the Internet 72 through an ISP 76b. The server 82 may support several workstations 84 connected in a network 86. The network 86 may be a local area network (LAN) or a wide area network (WAN), or the like. In certain embodiments, the enterprise server 82 may operate as the enterprise server 94. In other embodiments, a service server 90 may provide the functionality in accordance with the invention, that is, capture, auditing, reporting, archiving, and the like. Accordingly, in the embodiment of the server 82 in the network 86, a server portion of software operates on the enterprise server 82. Meanwhile, a client portion 88 or service client 88 operates on each workstation. A client may be thought of as any computer or software module that accesses resources stored on a server over a network connection. Accordingly, the actual execution of the various required functions in accordance with the invention may be accomplished on either the server 82 or the workstation 84, depending how the responsibilities are divided in an appropriate architecture to optimize speed, storage, reliability, and so forth.

A service module 80 may be hosted on an individual computer 11 used by an individual user 78. The service module 80 is responsible for capturing cache content from Internet browser(s), managing the capture and auditing procedures, as well as interfacing with the database management system relied upon by the service module 80 for storing data and editing data in accordance with the objectives of Internet monitoring, auditing, editing, reporting, and corrective action. The user 78 connects to the Internet 72 through an ISP 76a, which may serve other users 78, or other enterprise computer systems, gateway computers, proxy servers, and the like for Internet access by LANs or WANs.

In one embodiment, an enterprise server 94 may be configured to support a local area network 30 made up of workstations 96. In one embodiment, the same hardware, through appropriate software may operate as a proxy server 94, providing Internet access to each of the workstations 96. Accordingly, the overall enterprise computer system 92 or enterprise network 92 may rely on the proxy server 94 as a gateway to the Internet 72. The proxy server 94 relies on an ISP 76b to provide access to the Internet 72.

Accordingly, the proxy server 94 or enterprise server 94, realizing that two separate software modules accomplish the functions of network server and proxy server, although typically both may be hosted on a single hardware computer, or multiple hardware computers, at will, the service module 80 may be hosted in a centralized location, such as the proxy server or enterprise server 94 or each workstation 96 browser may access service module 80 via proxy client 95. The service module 80 thus accomplishes the capture, auditing, reporting, and so forth of the invention for all of the workstations 96 connected to the server 94. In this embodiment, every workstation 96 relies on the proxy server 94 to access the Internet 72 through the ISP 76b. Accordingly, the server 94 can always access any information that is incoming or cached by the workstations 96. Thus, no software is required on the workstations 96.

In yet another alternative embodiment, an ISP 76c may host a service module 80 for an individual user 78, an enterprise server 98, or any other connecting customer.

Accordingly, the ISP 76c may execute the service module 80 for all traffic traveling through the ISP 76c. Likewise, ISP 76c could host the entire proxy client 95 including service module 80. Accordingly, the ISP 76c can advertise and sell protected Internet access due to the responsibility the ISP 76c may take by executing the service module 80 to audit, capture, report, and so forth all activities of connected computers.

The ISP 76c may also provide services to other companies that run proxy caches 100. In some embodiments, an ISP 76c may thus provide a service to a proxy cache 100 owned by an independent third party, allowing the owners of the proxy cache 100 to offer services and advertise the audited and controlled nature of all content available through their proxy cache 100.

For example, it is known that people all over the Continental United States and in many foreign countries read certain newspapers online. If those newspapers are to be downloaded to every individual user, massive bandwidth is required. Thus, proxy caches 100 can regionally or locally download, in advance, copies of certain materials that are likely to be requested. Moreover, whenever certain requests are made, the proxy cache 100 may be consulted first, to determine whether or not such material has already been requested. Accordingly, once material has been requested by one user, such as the user 78, then any other user in the local area or region may find the material in the proxy cache 100, when a request for the material or URL access goes to the ISP 76c.

Of course, the proxy cache 100 may also host the service module 80 for its own benefit. Nevertheless, in certain embodiments, the ISP 76c may host the service module 80 for the benefit of all connected users 78, enterprise servers 98 (gateways, proxy servers), or other company ventures 100.

In yet another alternative embodiment, an enterprise server farm 83 may connect to the Internet 72 through an ISP 76d. A server farm may be thought of as a group of servers that are linked together as a single system image to provide centralized administration and horizontal scaleability. The server farm 83 may provide application server computing support to an enterprise. Application server computing may be defined as a server-based approach to delivering applications to end-user devices, wherein an application's logic executes on the server and only the user interface is transmitted across a network, such as an internetwork 72 or a network 86, to the client. Benefits of application server computing include single-point management, universal application access, bandwidth-independent performance, and improved security for business applications. In certain embodiments, the enterprise server farm 83 may provide the functionalities of capture, auditing, reporting, archiving, and the like in accordance with the invention.

The embodiment of the server farm 83 may include an application server 89 for serving applications 104, a web server 93 and a browser proxy client 95 on which a service module 80 may reside. An application server, such as an application server 89, may be thought of as a server that hosts and locally executes application software in response to commands issued by remote clients. Applications 104 may include any application designed for execution on a general purpose computer including without limitation word processing programs, spreadsheets, database programs, accounting programs, Internet browsers, and the like. In other words, an application server locally executes applications in response to commands sent across a network connection with a remote client (fat or thin), and the application server sends the results of the application execution back across the network connection to the client. In contrast, a file server, which may be defined as a centralized storage mechanism for files needed by a group of users, may send an application file to a remote client for execution on the client.

A web server, such as a web server 93, may be any server configured to serve files across Internetwork connections. The web server 93 is typically associated with caches of files received across network connections, which are stored in connection with the web server 93 to be served across network connections to remote web servers or clients.

A browser proxy client 95 may be a hardware computer configured with the capability of simultaneously providing the functions of a typical web server, such as a web server 93, and a typical client, such as a user 78. As appreciated by those skilled in the art, the application server 89, web server 93, and browser proxy client 95 typically constitute a collection of separate software modules that may be hosted on a single hardware computer or multiple hardware computers, for speed, reliability, and scaleability, at will.

The functionalities of the browser proxy client 95 may be provided by several software modules. A service module 80 may operate on the browser proxy client 95 to provide functionalities of capture, auditing, reporting, archiving, and the like to clients across network connections and to workstations directed toward or connected to the server farm 83. In this embodiment, all of the functionalities in accordance with the invention are provided within the server farm 83 and no “bit sets” or software is, therefore, required on the remote client or workstation, other than the normal browser.

In one embodiment, the proxy cache 76e may actually be hosted by an ISP 76e. That is, the service module 80 may be hosted by an ISP server 76e that also hosts, on the same or separate hardware, a proxy cache. Thus, the proxy cache ISP 76e may represent a service in which an ISP 76e provides proxy caching services. That is, many individual companies, as well as certain services, provide proxy caches 100 specifically for the needs of customers. Nevertheless, an ISP 76e may also provide proxy cache services. Alternatively, an ISP 76e may provide proxy caching simply as a mechanism to save bandwidth to the Internet 72. Thus, the ISP 76e connects to its universe of subscribers, just as other ISP's 76a, 76b, 76c, 76e, 76f will do.

In yet another alternative embodiment, an Application Service Provider (ASP) farm 102 may provide various applications 104 over the Internet 72. An ASP typically deploys, hosts, and manages access to an application, such as an applications 104, to multiple users from a centrally managed facility. An ASP also typically delivers applications 104 over networks on a subscription basis. Moreover, ASPs are designed to speed implementation of new applications, minimize the expenses and risks borne over an application's life cycle, and ameliorate the problems associated with the current shortage of qualified technical personnel in the marketplace.

Since the ASP server farm 102 may provide any application 104 from word processing to graphics engines, to specialized commercial software, a service module 80 may be hosted by the server farm 102, in order to provide audit, monitor, and control services. Note that reference to the ASP 102 itself refers to the entity providing applications 104, and the ASP server farm 102 constitutes the computer software hosted on particular computers 11 in order to accomplish the functionality of the ASP business entity. Nevertheless, it is proper here to refer to either one as the ASP 102 or ASP server farm 102, since, from a computer point of view, they are represented by the same software and hardware to the ISP 76e and the Internet 72.

In the depicted embodiment, the server farm 102 includes an architecture very similar to the architecture disclosed an discussed in connection with the enterprise server farm 83. However, the depicted embodiment includes a firewall 107, which is typically implemented as a set of rules defining access to the ASP server farm 102. Of course, a firewall 107 could be implemented in a variety of locations on the network depicted in FIG. 2 including without limitation between server farm 83 and ISP 76d or between Internet 72 and ISP 76b.

As shown, an ASP server farm 102 may include an application server 89 for serving applications 104, a web server 93 for receiving and sending files across internetwork connections, a browser proxy client 95 for functioning as a web server and as a proxy client to applications 104. Thus, the browser proxy client 95 acts as the ASP's interface between application server 89 and a user 78. In the depicted embodiment, the browser proxy client 95 also includes a service module 80 for providing the functionalities of control, capture, auditing, reporting, and the like, in accordance with the invention, to client browsers across network connections. In depicted embodiment, all functionalities in accordance with the invention are provided within the ASP server farm 102, and no software is, therefore, required on remote clients or workstations served across network connections by the server farm 102.

The ASP server farm 102 may alternatively rely on a proxy cache 106 dedicated to its own service. Accordingly, the ASP server 102 may rely on any of the configurations discussed, and multiple entities accessed by the ASP server 102 may have service modules 80 for their own purposes. Thus, any combination of service modules 80 in any computer connected to the Internet 72 is contemplated. That is, individual users 78 may host service modules 80 in order to permit owners of particular computers to audit and report use of those computers. Similarly, any company owning an enterprise server 82, 94 may desire to host a service module 80 for its own purposes.

Similarly, either a single integrated module 80 or a client 88 and server 90 model of the service module 80 may be implemented. Similarly, ISP's 76 may host service modules in order to provide protection or monitoring services, which may be a draw for customers to such ISP's 76. By the same token, proxy cache services 76d may host service modules 80, in order to provide assurances to entities accessing those proxy caches 76d hosted therein. Moreover, ASPs 102 may host service modules 80, in order to assure that applications 104 provided to various customers will not be used as vehicles for inappropriate content delivery.

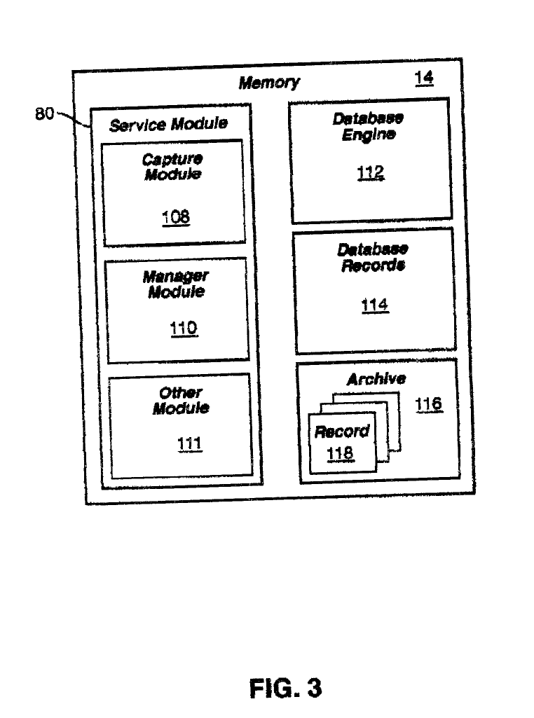

Referring to FIG. 3, in one embodiment, a memory device 14 in a computer 11, which computer 11 may be disposed in any combination of the configurations of FIG. 2, a service module 80 may include a capture module 108, a manager module 110, and other modules 111. In certain embodiments, the service module 80 may either include, or may access outside itself, a database engine 112 for managing database records 114. Typically, the database records 114 constitute a database 114.

Meanwhile, a database system typically includes a standard, well known, reliable database engine 112 operating according to some schema to make, create, edit, retrieve, and otherwise manage database records 114. An archive 116 may be configured in numerous ways. In one embodiment, an archive 116 simply represents a particular database record 114 marked to preclude deletion or editing. In another embodiment, an archive 116 may actually be another copy of a database record 114, or a subset of a database record 114, inaccessible to a user or owned or controlled by a third party, such that one accessing the database engine 112 from any other location than that of the owner of the archive 116, cannot access the archive 116.

In one embodiment, the capture module 108, as every other module in accordance with the invention, may be any thing from a single machine-level instruction, to an entire multimedia application. That is, an individual module 80, 108-116 can physically be stored in any size, shape, configuration, on any number of computers, in order to execute its function. Thus, the capture module 108 is that code that is logically executed in order to effect the capture process for capturing the content of Internet caches relied upon by browsers. Meanwhile, the manager module 110 is responsible for managing the processes of auditing, reporting, archiving, and the like, as well as any filtering, blocking, or filter teaching that may be required. Other modules 111 may be created to provide other services, or to support the capture and management processes.

In general, the database engine 112 may be any commercial database engine, such as those produced under the current ODBC standards, the commercial products such as Oracle™, Sybase™, and others known in the art. The database records 114 may be those created in accordance with a schema, or hierarchy in any format, whether conventional, relational database, lists, object-oriented databases, or the like. Necessarily, the archive 116 must bear some relationship to the database record 114, and may rely on the same database engine or another. Meanwhile, the archive 116 may be abstracted records, exact copies of records, marked records of the database records 114, or any appropriate data structures required to provide independent, and permanent control of the information in a database record 114 once it has garnered certain interest and a desire for being saved, or more permanently or securely stored.

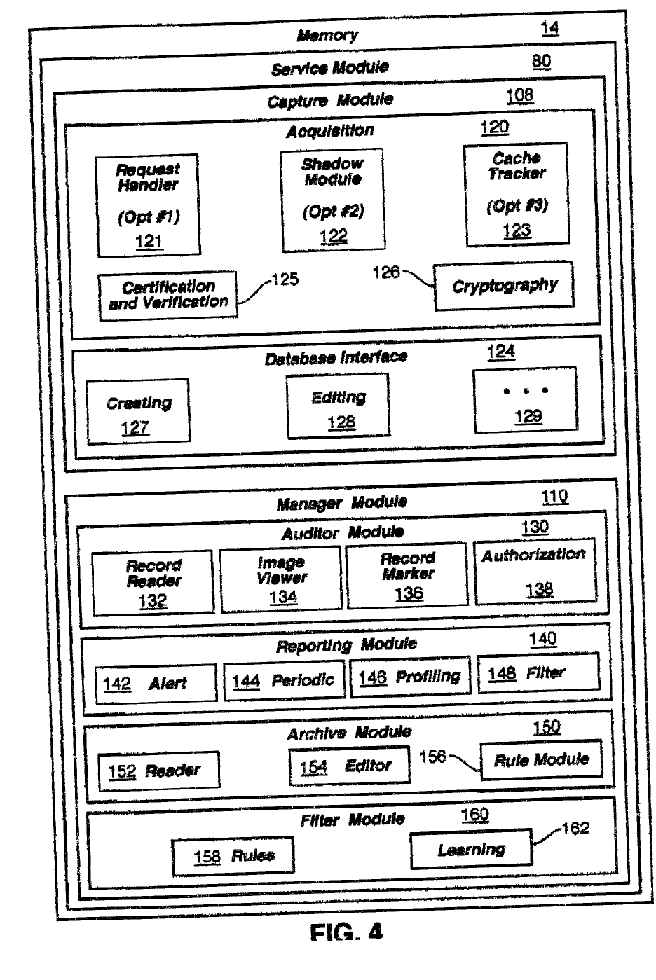

Referring to FIG. 4, a service module 80, may be configured in any suitable arrangements to execute on one or more processors 12. Thus, distributed processing, client/server architectures, application server architectures, and the like may all be used, in order to host a service module 80. A service module 80 may include all the functionalities of an apparatus and method in accordance with the invention. Alternatively, a service module 80 may be distributed to provide a portion of the services, supported by other modules feeding particular individual functional processes or information to a principal service module 80.

In one embodiment, a service module 80 may include a capture module 108, a manager module 110, and other executables required for additional administrative or other service functions. In general, a capture module 108 may include an acquisition module 120 responsible for acquiring browser cache content or Internet cache content accessed by users over the Internet 72. The acquisition function may be executed in several ways. In one embodiment, a request handler 121 may actually receive and comply with a request for access to a uniform resource locator (URL) sought by a user 78.

By a user 78, is intended any individual computer 11 accessing any content over the Internet 72 regardless of the networked or non-networked configuration of the individual computer 11 with respect to other computers generally. Thus, a request handler 121 actually receives and executes on any request for content. Accordingly, the request handler 121 actually processes or handles every URL, and thus can access all of the content retrieved. Accordingly, a request handler 121 is in an excellent position to capture all content before it even arrives at the browser cache of an individual user 78. Moreover, the request handler 121 can simply send content in response to a request to two locations, one being the requester, and the other being a database record 114 of the service module 80.

In an alternative embodiment, a shadow module 122 may serve the acquisition function 120 by simply receiving all content, or other information determined to be important for monitoring and auditing activities of an individual user 78. The shadow module 122 may be remote from a user 78 over the Internet 72, yet due to a service or subscription service or the like provided to a customer who has control of the user computer 78, the shadow module 122 receives a copy of each request, each response to request, or other information generated by an individual user 78. Thus, the shadow module 122 does not intervene, as does the request handler 121, and is not in the direct line of command and response. Nevertheless, the shadow module 122 is on a parallel path that receives the information, as it is generated by and received by the computer 11 corresponding to any user 78.

Another option in the acquisition module 120 is a cache tracker 123. The cache tracker 123 is neither in the command, request, or response path as the request handler 121, nor targeted as a parallel receiver as the shadow module 122. Instead, the cache tracker 123 accesses and caches meta data of any computer 11, in accordance with instructions. Accordingly, the cache tracker 123 observes and obtains all content, or other information passed to or from a computer 11, and designated for capture by the capture module 108. That is, numerous types of information may be captured. Captured information may include meta data, images, movies, video, audio, streaming multimedia, HTML Text, XML Text, e-mail text, chat room traffic, and the like. Meta data in text form from web sites, application calls, registry information, files, windows, object calls, individual keystrokes from a computer 11, and the like may all be captured and stamped with identifying information including without limitation user, date, and time. Likewise, any information sent to or from an individual computer 11 that is subject to audit by the service module 80, may be rendered accessible and recordable by the cache tracker 123 responsible to capture such monitored information.

In certain embodiments, an acquisition module 120, or another module related to the service module 80 may provide additional services. Two important services contemplated are certification and verification. A certification and verification module 125 may include either or both functions. The functions differ slightly in that verification is often done by symmetric or asymmetric cryptographic key systems. Likewise, verification may be done by digital signatures. Certification typically refers to assuring under financial and other penalties, underwritten by a certification authority, that a fact, identity, content, or the like is true. Accordingly, a certification authority may certify through the certification and verification module 125, that each participant in a communication over the Internet 72 is indeed the individual person, computer, hardware, software, or human entity designated and indicated by computer communications. Such certification is not always easy, but may be enforced by numerous mechanisms. In certain embodiments, a certification authority may require, through a certification module 125, that an individual human being provide sufficient information, clearly documented over the Internet 72, facts sufficient to establish an identity. Accordingly, the certification module 125 may provide true binding between information, Internet content transferred, and individual human beings as well as hardware and software used, in order to establish responsibility, reliability, veracity, factual evidentiary support, or the like as required.

Another module that may provide additional services may be a cryptography module 126. Cryptography may be used to avoid sending information in the clear between the service module 80 and the data base records 114. For example, access by third parties may be inadvisable. In many embodiments, an enabling keyed access through cryptographic engines 126, or encrypting transmissions through cryptographic modules 126, or encrypting images that will be saved in data base records 114 may all be served by cryptographic engines 126, such as a cryptography module 126. Nevertheless, the cryptography module 126 may simply access a cryptographic engine remote from the service module 80. Numerous technologies and architectures exist to perform cryptographic functions. The cryptography module 126 bears the responsibility for providing such services to the capture module 108, and particularly to the acquisition module 120 thereof, in at least one embodiment.

Referring to FIG. 4, a database interface 124 is not absolutely essential. However, most database engines 112 are not particularly user friendly. Accordingly, in one embodiment, a database interface 124 provides a simple and straightforward interface between a service module 80 and the database 112, 114. Thus, graphical user interfaces, automated interfaces, automated executables for creating 127, editing 128, or otherwise administering 129 may exist within the database interface 124, in order to obtain the benefits of a database engine 112 and database records 114. Thus, the necessary programming required to interface with the database engine 112, may be embodied in a creating module 127, and an editing module 128, and other modules 129. For example, certain administrative modules 129 may include functionalities ranging from mining, learning, sorting, filtering, or otherwise processing information going to or from the database records 114.

In general, the database interface 124 may be responsible for obtaining the results available through a database engine 112, as adapted to the use of the service module 80, in general, and the capture module 108, in particular. The database interface 124 may also be adapted to serve the manager module 110. Nevertheless, in some embodiments, the database interface 124 may actually have counterparts in both the capture module 108 and the manager module 110. Thus, the architecture is somewhat arbitrary as to the specific physical location of a database interface 124. Nevertheless, a logical location of the database interface 124 in the capture module 108 is valuable to capture and download image content, data, and meta data from Internet browser caches owned or controlled by subscribers to services provided by the service module 80.

In certain embodiments, a manager module 110 may include an auditor module 130. The auditor module 130 may rely on the database interface 124, or may have a counterpart thereof for accessing the databases 112. In general, the auditor module 130 has responsibility for providing access to database records 114 for review and judgment. For example, the auditor module 130 may provide a record reader 132 in order to access database records 114, or selected fields of individual database records 114. That is, once a database record 114 has been created, access thereto may be restricted to individuals depending upon their particular responsibilities. Thus, certain modification of fields in the database records 114 may be prohibited even to an auditor. Nevertheless, other access may be required in order for an auditor to fulfill the responsibilities for which the auditor module 130 is executed.

In one presently preferred embodiment, an image viewer 134 provides a comparatively fast review of individual images stored in the database records 114. For example, the image viewer 134 may provide either compressed versions of images, or highly compressed time sequences, in which streams or blobs of data, representing images, can be rapidly displayed to view. Accordingly, the image viewer 134 may provide a review within seconds of image data that was actually collected over weeks. A tremendous advantage of the image viewer 134 is the high speed of display. Visual images are instantly recognizable, and retained for a fraction of a second in the mind of a user. By contrast, text is often cryptic in format, difficult to read, and difficult to assimilate by the eyes. Moreover, text content may have very difficult interpretation in order to have meaning. In fact, text content may often be best handled by parsers and mining engines that are programmed to search for combinations in characters. Accordingly, automated functionalities may be provided in a record reader 132 in order that a human user need not pour over cryptic records that are not easily recognizable. By contrast, communication bandwidth is extremely high for images, and the image viewer 134 may be directly accessible to a human auditor. In certain embodiments, sophisticated image processing may substitute for a human user in the image viewer 134.

A record marker 136 may be simple or sophisticated. One principal functionally of a record marker 136 may be designation of selected database records 114 for further review, reporting, or the like. Thus, in certain embodiments, a record marker 136 may be an output module 136 for an auditor module 130. Accordingly, a record marker 136, may save out a record, copy a record, or literally edit a record 114 in order to designate some classification or judgment exercise by the auditor module 130.

In certain embodiments, an authorization module 138 may provide functionality for establishing authorization of individuals accessing the auditor module 130. For example, individual users may be permitted to audit their own Internet access records. Likewise, managers may be permitted to monitor Internet access records of employees. Independent auditors may be permitted to access Internet access records of anyone in a customer company using the services of the service module 80. Accordingly, the use of the auditor module 130 may be controlled to some practical extent by an authorization module 138 brokering access thereto. Accordingly, access and editing privileges may differ somewhat. For example, an individual user may be free to access records, without being able to edit them or delete them.

In certain embodiments, a manager module 110 may include a reporting module 140. A major responsibility of the reporting module 140 is to provide appropriate notification to responsible authority of the results provided by an auditor module 130. For example, an individual computer or an individual user station 78 may be monitored by a parent, to determine what children are accessing. By contrast, a manager or MIS professional, or security professional may be responsible for reviewing the results from an enterprise server in 82, 94 or an ISP system 76c or other commercial system such as a proxy cache server 76d or ASP server 102.

In certain embodiments, a reporting module 140 may include an alert module 142. Typically, an alert module 142 may be regarded as an acute problem identification mechanism. Thus, an alert module 142 may notify an individual in a comparatively short time, such as within seconds or a day that a particular computer 11 has accessed certain information, that has been determined to be inappropriate, in accordance with rules provided an auditor module 130, and processed accordingly. Meanwhile, a reporting module 140 may or may not include an alert module 142, nevertheless, the reporting module 140 may or may not include a periodic reporting module 144. A periodic module 144 or periodic reporting module 144 may be responsible for providing some type of reviewable output to a responsible authority. For example, a reporting module 140 may provide a report on demand, or a report on a schedule. Thus, the periodic module 144 may provide such a report in accordance with an appropriate schedule or other scheme for providing a desired report. A customer or a service providing the service module 80, or an owner of an application embodying the service module 80, may determine a desired frequency or schedule for the periodic reporting module 144 to provide reporting materials.

In certain embodiments, a profiling module 146 may provide additional analysis of data from reports. Profiling modules 146 are not necessarily required. In many instances, a periodic report in which an image viewer 134 is provided to a manager, a few seconds of review can display all the images seen in a day. In actual practicality, five minutes is sufficient time to review all of the significant images viewed by a user of the Internet 72 over a period of two to three weeks. Nevertheless, a profiling module 146 may evaluate meta data retrieved from an Internet browser cache, or from other message traffic received b, an individual user 78 over the Internet. Thus, a profiling module 146 may analyze any amount of data relating to a user 78, including but not limited to the access of such a user 78 to content over the Internet 72. Content may include information ranging from images, video, sound, text, and other data sent over the Internet 72 back in response to requests down to local application calls and individual key strokes made on a computer. Thus, virtually any level of detail can be collected, and transferred in a highly compressed format to be evaluated or stored remotely. In certain embodiments, a filter 148 may provide information even if the user 78 has only network access or limited Internet access.

In certain embodiments, a filter module 148 may provide information to be used in filtering. Filtering has been unable to accomplish the overall needs of Internet content protection for parents or management of companies. Nevertheless, providing important information to a filter module 160 may be a mechanism for rapidly implementing on a larger scale, what has been gleaned by the acquisition module 120, and the auditor module 130. Thus, the filter module 148 may provide the results of the capture and auditing functions in a format usable by a filter in a broader context. For example, just as a proxy cache in a company, in a building, in a local location, or in a regional location can be consulted to determine whether certain content is readily available, before accessing other resources more remote on the Internet 72, much time and effort can be spared.

Accordingly, providing immediate information regarding results of the auditor module 130 and the capture module 108, the filter module 148 or filter reporting module 148 may provide information suitable for providing almost real-time filtering and categorizing of content, rather than requiring the same content to be repeatedly accessed and audited. For example, certain requests often bring up inappropriate content from sites that are not desired. Accordingly, proper filtration can result from earlier audits, thus precluding additional access to such sites in the future.

The archive module 150 has responsibility for managing archives 116, and particularly the archive records 118. Thus, the archive module 150 may provide some interface to the database engine 112. Likewise, the archive module 150 may access the database interface 124, exactly the same as does the capture module 108. By whatever means, the archive module 150 has administrative responsibility for creating and maintaining archive records 118. That is, the database engine 112 may actually edit and save archive records 116 or the archive module 150 may create separate archive records 118 in an archive 116, in a database different from the database record 114. By either mode, the archive module 150 may provide a reader 152, an editor 154, and a rule module 156 governing the rules of archiving. One important function of the archive module 150 is to provide independent and inaccessible control over selected archive records 118 of interest. Archive records 118 are those records that are required to support an ongoing periodic reporting module 144, or to support ongoing investigations or corrective action. A rule module 156 may include executables for complying with rule data provided elsewhere, or may include rule data and means for executing on the rule data in order to maintain clean, accessible, effective, and otherwise useful archive records 118.

The filter module 160 is highly optional. Filtering is not required. Nevertheless, a filter module 160 may include a rules module 158 embodying templates, profiles, state definitions, lists, directories, and the like for effecting filtration of content accessed over the Internet 72. In certain embodiments, the filter module 160 may include a learning module 162. That is, numerous types of inferences may be drawn in accordance with filter information provided by the reporting module 140. Similarly, results of the auditor module 130 may result in alerts 142 or periodic reports 144 containing data that may remain, and which may be used for inferential learning by a learning module 162. Accordingly, a learning module 162 may be simple or crude, but may implement immediately the results of the reporting module 140, in order to maintain a set of rules for a rule module 158, suitable for minimizing the labor required by the auditor module 130 and individuals associated therewith in auditing sites and access thereto. Accordingly, individuals may be spared wasted effort or embarrassment associated with access to inappropriate content. Meanwhile, bandwidth may be freed up for work, by virtue of both cessation of access by users to inappropriate sites and content, as well as by the lack of any necessity to transmit large image files, thus lowering traffic by two mechanisms.

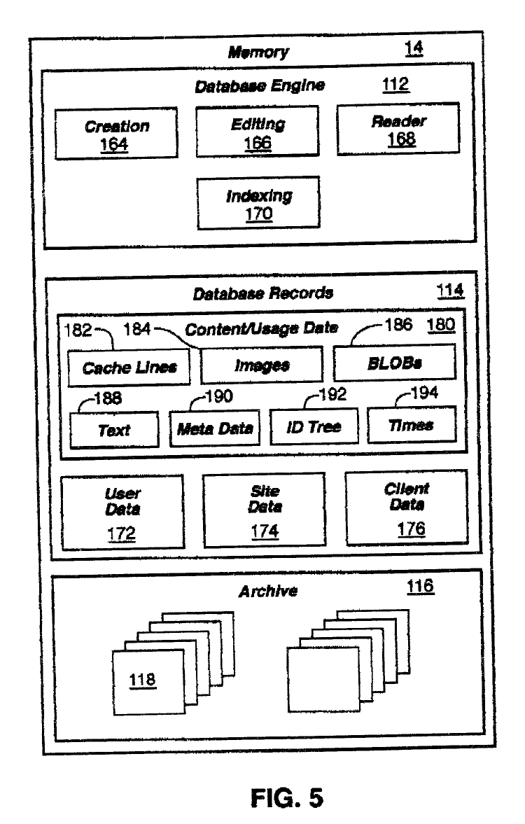

Referring to FIG. 5, a memory device 14, whether embodied in volatile or nonvolatile memory, and whether or not embodied in one physical location or multiple physical locations, may be loaded with modules for supporting management and other associated functions related to database records 114. In one embodiment, a database engine may have executable functionality amounting to a creation engine 164 responsible for establishing new records. Similarly, an editing module 166 may permit editing by an appropriate authorized individual accessing the database records 114. Similarly, the editing module 116 may have counterparts in other software, or may be the principal engine accessed by other interface modules in order to permit appropriate editing of database records 114 in accordance with selected authorization.

A database engine 112 may include a reader 168 and an indexing module 170 for creating and maintaining an indexing system. Additional functionality may be provided as known in the art for the database engine 112. Meanwhile, the database engine 112 may provide the principal executables, and selected Application Programming Interfaces (APIs) for various database interfaces 124 requiring communications with the database record 114.

The database records 114 may contain any suitable information determined by an architect of the database system 112, 114. Accordingly, database records 114 may include, in each record, or in various records, information including user data 172, relating to individual users or workstations. Site data 174 may relate to any information, whether image data or meta data or any suitable suite of information available and useful with regard to sites accessed by a user and reported through the service module 80. Similarly, client data 176 may refer to customer information 176 provided by users of services provided by the service module 80. Perhaps most important, and preferably bound in one or more ways to user data 172 and client data 176, is the content data 180 or content/usage data 180 bound to clear identifiers necessary to identify user data 172 and client data 176 corresponding thereto.

Content data 180 may include various types of data. In some embodiments, the content usage data 180 may actually include cache lines 182 from caches or buffers. Likewise, images 180 stored by Internet browser caches may be stored in usage data 180. In some embodiments, Binary Large Objects (BLOBs) 186 may actually stream together large amounts of data, without regard to bounding all information from all other information therewithin. BLOBs 186 may be a convenient mechanism for storing and retrieving large amounts of visual information quickly. Meanwhile, text data 188 or simply text 188 may have significance and may be captured by the capture module 108 according to particular rules. Meta data 190 or an identification tree 192 corresponding to user data 172 can effectively bind content data 180 to user data 172, and may be included in the content data 180 or in the user data 172. Similarly, time stamps and other temporal data may be stored in a times module 194 thus indicating access time if it is significant. Time may include duration as well as time of day and date.

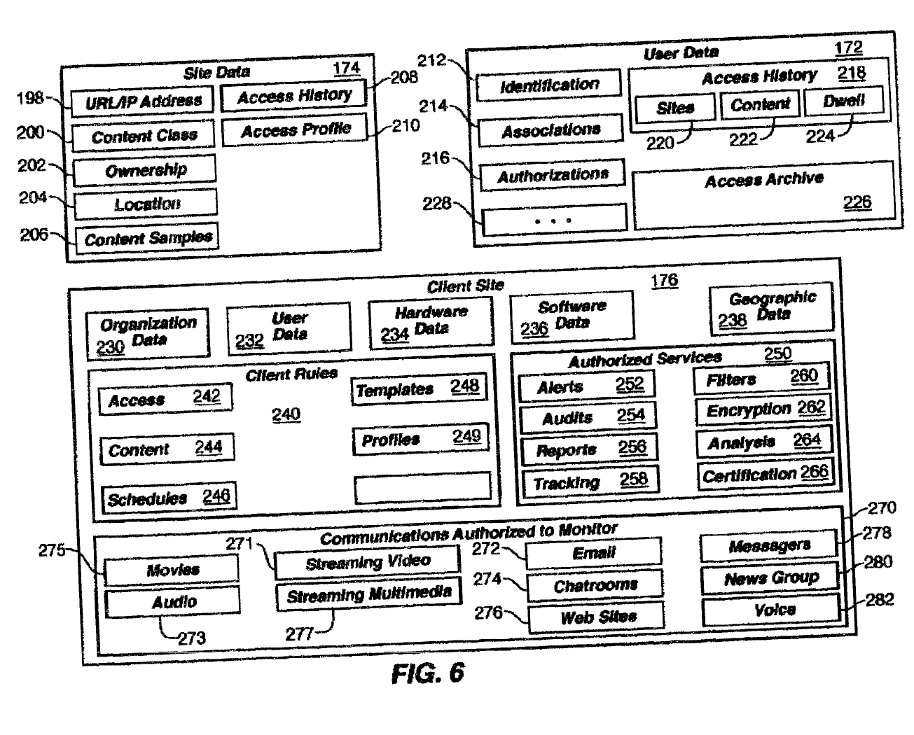

Referring to FIG. 6, site data 174 may be used for reporting or filtering. Site data 174 may include anything of interest, such as address information 198. Address information 198 may include LRLs 198 or IP URL addresses 198. IP addresses may be more readily tied to particular servers, hardware, and network participants providing content access by a user 78. A URL may identify particular content, but may be nested in a comparatively obscure way. Nevertheless, both types of information may be regarded as address and information 198 collected as site data 174. In certain embodiments, site data 174 may include content class 200 or classification 200 identifying certain information about content in an abbreviated format. Similarly, ownership information 202, location data 204, whether physical, logical, network, or the like, much may be known about a site, or may be gathered. Content samples from a site may be provided as site data 174, and an abbreviated or complete access history 208 may help in determining a comparative utility of a particular site. In that regard, access profiles 210 may include analysis of the access history 208, placed in a readily usable form for use by the service module 80.

User data 172 may again be saved in any suitable format, such as in an object oriented database, as part of a database record, as a separate set of tables or records linked to database records, and may provide suitable information such as identification 212 of any type, associations 214 by a user, authorizations 216. An access history 218 may provide information or links to information regarding site access data 220, content access data 222, and dwell time data 224. In some embodiments, a relational database or object oriented database may provide rapid pointing and indexing in order to link access history data 218 to site data 174 and user data 172. Likewise, an access archive 226 may provide identification or pointers linking user data 172 with particular content.

Client data 176 may include any amount of administrative or operational data useful to a service module 80 and accomplishing all of its substantive or administrative functions. For example, organizational data 230 may identify organizational structures associated with a particular client (customer) relying on operation of a service module 80. User data 232 may relate to something as simple as linking one database table to another, or one database object to another in order to identify a user with a customer identified in the client data 176. Also useful hardware data 234 may relate to individual hardware encountered or identified as installed at a particular customer location. Similarly, software data 236 may identify software applications running or authorized at a customer company. Geographic data 238 may be related to actual civil region, or may be associated with a physical identifier corresponding to a particular factory or plant of a customer.

Client rules 240 may include information provided by a client, or developed for a client in order to properly conduct audits and reports directed to Internet content access. Client rule data 240 may include access data 242 identifying individuals and corresponding rights to particular information. Likewise, actual content 244 may be characterized, or content 244 may be saved. Schedules 246 or sampling, testing, auditing, archiving, and the like may be provided in client rules 240.

Authorized services data 250 may include various types of activity controls for operation of the one or more service modules 80 relied upon by a client for monitoring and auditing Internet, Intranet, or Network access. Authorized services 250 may include alerts 252, audit controls 254, report information 256, tracking information 258 for particular cases that have acquired interest by operation in accordance with audits 254 and reports 256, and the like. Also, filters 260, which may include templates for determining what is accessible or non-accessible by users, and whether or not policies of clients have been complied with in accessing the Internet 72. Encryption authorization 262, analysis authorization 264 may authorize additional manipulation or processing of database records 114 or archive records 118. Meanwhile, certification authorizations 266 may identify services that may be provided by the service module 80 to a particular customer.

Numerous communication processes or sources may be provided in different formats. Similarly, different communications may be executed using different hardware or software, and may vary substantially in the ability to monitor them. For example, a list 270 of communications authorized to monitor by the service module 80 may include email 272, chat rooms 274, web sites 276, messagers 278, news groups 280, voice communications 282, streaming video 271, audio 273, movies 275, streaming multimedia 277, and the like over the Internet 72, or voice communications 282 whether by conventional telecommunication lines, or over the Internet through a computer 11. Virtually any communications may be monitored that have any type of computerized controls. Many companies have computerized telephone systems, that are completely digital, and interface through specific communication servers to the overall, conventional, analog telecommunications networks. Nevertheless, to the extent that a computer handles or manages communications, such a communication may be monitored as appropriate.

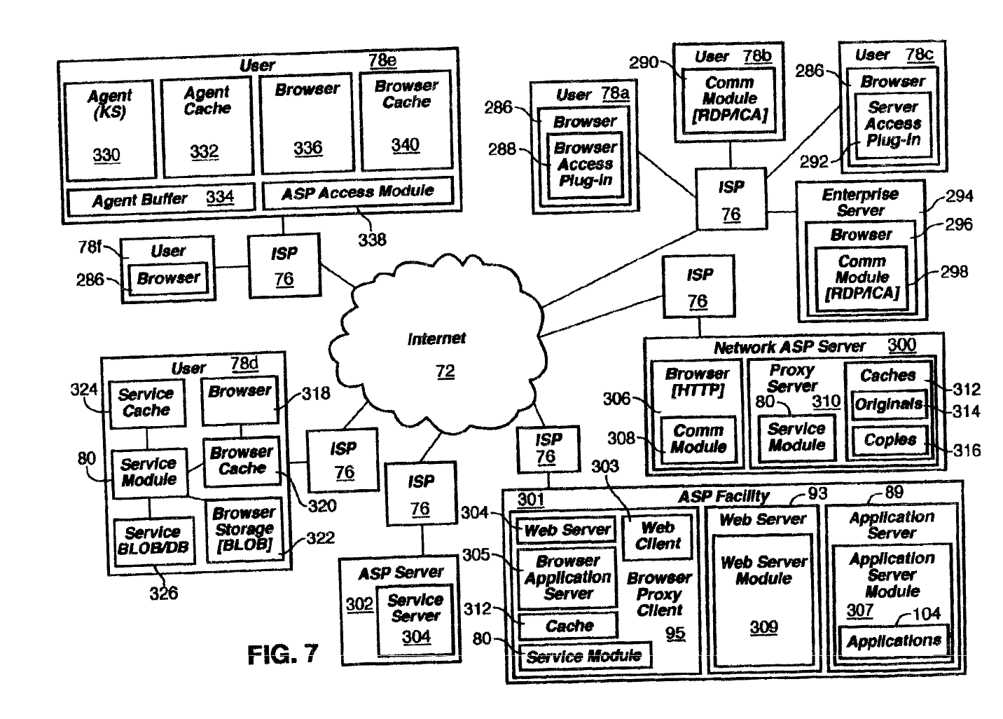

Referring to FIG. 7, various architectures may serve for implementing a service module 80. In one embodiment, a user 78a may be thought of as a computer associated with a human being, the computer 78a hosting a browser 286. Browser 286 may have a plug-in module 288 responsible for controlling communication between the browser 286, and other computers. The plug-in 288 permits operation of a service module 80, via comm module 308. The plug-in 288 may be hosted in the browser 286 or may be hosted outside the browser 286 on the computer 78a. The plug-in 288 is not limited to the meaning of the term plug-in as used in the computer arts but may be any software construct that permits operation of a service modules 80. In alternative embodiments, a communication module 290 may communicate in a somewhat more cryptic and direct method with a remote computer 300 responsible for providing the services of a service module 80 via comm module 308. For example, a communication module 290 may communicate between a user computer 78b, and a server 300 provided by an ASP or other service provider of the service module 80 services.

Whereas a plug-in module 288 interacts with a browser 286 of any particular vendor, the com module 290 typically relies on an RDP or ICA protocol, or other protocol providing similar functionality in order to communicate directly with a remote computer providing browser 306 and service module 80. Accordingly, the functionality of the service module 80 may be supported at a subscriber's computer by the plug-in 288 or the corn module 290. In an alternative embodiment, a server access plug-in 292 may operate with a browser 286 to access a server in order to provide to such a server the access history of a browser 286. Thus, the server access plug-in 292 may communicate in an HTTP protocol to communicate the access history of the browser 286. The server access plug-in 292 may communicate in the HTTP protocol or the like.

In yet another embodiment, an enterprise server 294 as described above, may host a browser 296 provided with a communication access plug-in 298. The communication access plug-in 298 may communicate in an RDP protocol or an ICA protocol or the like. The Comm Module 298 works within or independent of the browser 296, in response to the enterprise server 294 being authorized for monitoring by the owner thereof, and engaging the services of an ASP server 300 or network server 300 for accomplishing the functionality of the service module 80. Accordingly, a network server 300 or ASP server 300 remote from a particular server 294 or user 78, may operate in various manners. For example, in one embodiment, an ASP server 302 may represent the computer or entity, and a service server 304 may provide the services associated with the service module 80, or other services, such as word processing, email, or the like.

Nevertheless, in certain embodiments, an ASP server 300 may actually provide the browser 306 used by any subscriber such as a user 78 or enterprise server 294. Accordingly, the browser 306 may optionally operate in the HTTP protocol. Alternatively, the browser 306 may be accessed through a communication module 308 by a communication module 290 in a user 78b, or a communication access plug-in 298 in an enterprise server 294. Alternatively, the browser 306 may be accessed by a browser access plug-in 288 using the HTTP protocol, or a server access plug-in 292 in a browser 286, operating under the HTTP or other standard protocol. Thus, the browser 306, may operate as a browser 306 within a browser 286, 290, 296, or may serve as the only browser via access module 288, 290, 292, or 298.

In certain embodiments, the network server 300 or ASP server 300 may host a proxy server module 310 implementing a service module 80. The service module 80 may access caches 312 including original caches 314 relied upon by the browser 306. Also, the service module may create and rely on copies 316 of the original caches 314, in order to effect the previously discussed procedures for capturing and auditing access records. Since the network or ASP server 300 implementing a proxy server 310 is the server 300 by which the Internet is accessed, the original caches 314 are readily available for review.

In another embodiment, an ASP facility 301 or ASP server farm 301 may include a browser proxy client 95 hosting a service module 80. In this embodiment, additional “bit sets” 288, 292, and 298 are not required because the browser proxy client 95 hosts service module 80 and communicates directly from its web server 304 to browsers 286, 296, as does user 78f. An ASP facility 301 is typically configured as a server farm 301, falling under the application server computing model, comprised of many hardware computers that are managed as a single entity and share some form of physical connection. In the depicted embodiment, an application server 89 of the server farm 301 may function as an application serving back end. The application server 89 may host an application server module 307 that may respond to requests by a web server module 309, typically hosted on a web server 93, for application set information for formatting into HTML pages that a user, such as a user 78f, can view in a typical browser 286. The application server module 307 may respond to request of a user 78f, typically passed via a web client 303 and the web server module 309, for an application by initiating the hosting of a session on the application server 89 containing the application requested by the user. Typically, 100% of the hosted application's processing is performed within the hosted session on the application server 89.

The web server module 309 may perform a variety of functions that facilitate communication between a user, such as a user 78f, and the application server module 307 of the application server 89. For example, the web server module 309 may provide application icons for a user 78f to activate to begin accessing applications 104 hosted on the application server 89. The web server module 309 may also modify properties of individual applications 104 before presentation to users 78f, retrieve individual user application sets from the application server 89 (typically using HTML, XHTML, XML via the HTTP protocol), and interface individual users 78f to the application server 89. Typically, only the user interface portion of the execution of an application 104 on the application server 89 is passed through the web server module 309 and the web client module 303 to the browser application 305 for presentation to the user 78f.

The browser proxy client 95 typically hosts the web client module 303, a web server module 304, a browser application 305, a set of caches 312, and a service module 80. The web client module 303 typically functions as the engine that actually causes the launching of applications published by the application server module 307. The web client module 303 and the browser 305 work together as a viewer and an engine. The web browser application 305 enables a user 78f to view application sets, created by the web server module 309.

The service module 80, which is typically hosted on a browser proxy client 95, may perform the functions of control, capture, auditing, reporting, and the like through access provided by web server 304. The service module 80 may, of course, access caches 312, which may be similar to caches 312 disclosed in connection with server 300.

Typically, the browser proxy client 95 of the ASP facility 301 includes the web client module 303, the web server module 304, and a browser application 305. The browser application 305 may serve a browser application, such as a browser 306, to the user 78f to be displayed within a browser 286. Accordingly, as discussed above in connection with browser 306, the browser application 305 may serve a browser application displaying the application sets, provided by the web server module 309, within the browser 286 for use by the user 78f. Moreover, in the depicted embodiment, the ASP facility 301 may publish applications 104 into the web browser 286 of the user 78f without the requirement of installing a client component, such as a browser access plug-in 288, comm module 292,298 or the like, on the user 78a, 78c, 294, or 78f.

In yet another embodiment, a browser 318 may be hosted directly on a user computer 78d. The browser 318 may access a browser cache 320. By hosting a service module 80 in the user computer 78d, an owner of the user computer 78d may have a service cache 324 operating to store the important information required by the service module 80, including content accessed by the browser cache 320. Nevertheless, in certain embodiments, an individual user 78d may rely on the service module 80 to create a service database or service Binary Large Object 326 (BLOB 326). Similarly, the service module 80 may access the browser cache 320 in order to create browser storage 322. The browser storage 322 may optionally be stored as a binary large object. In certain embodiments, the service module 80 may provide all of the services discussed heretofore. In alternative embodiments, the service module 80 may simply prepare the binary large objects 322, 326 for communication with a server 300 operated by an ASP.

In one alternative embodiment, a user computer 78e, or user 78e may host one or more optional software modules in order to communicate with an ASP server 300. Typically, a compressed screen image 328 may be communicated in RDP or ICA protocol and will forward information that has been saved over some period of time when a user computer 78e is not online. For example, an individual user 78e may actually operate offline during much of the useful time. Meanwhile, various activities may still occur. In one embodiment, an agent 330 may actually store a record of virtually every keystroke, thus saving information regarding applications accessed, email sent, chat room contacts, and the like. The agent 330 may store such information in a suitable, space-saving format in an agent cache 332. As the agent cache 332 is turned over, an agent buffer 334 may be used as temporary storage. Eventually, when the user computer 78e is logged onto the Internet 72, the agent 330 can communicate correctly with an ASP server 300 to download the contents of the agent buffer 334 or agent cache 332. The functions of the agent 330 may also be performed by a service module 80.

In one embodiment, the user 78e may also have a browser 336 for accessing the Internet 72. The ASP access module 338 may exist on the user 78e independent of the browser 336 and track all Internet access by downloading in compressed screen images 328 or binary large objects, the contents of the browser cache 340 and agent buffer 334 to an ASP server 300. Thus, regardless of whether a computer is operated primarily over the Internet 72, or is operating as a stand alone machine, all activity may be tracked, and reported to an authority or owner, by way of an embedded service module 80 within the computer, or by way of modules 330, 338 reporting to a network or ASP server 300 periodically.

In an alternative embodiment, a user 78f may have a browser 286 for accessing the Internet 72, and more specifically the depicted ASP facility 301. Like the user 78e, the user 78f may also host an agent 330, an agent cache 332, an agent buffer 334, and a browser cache 340, all of which function as described above. Obviously, the functions of an agent 330, an agent cache 332, an agent buffer 334, and a browser cache 340 may also be performed within the service module 80 hosted on the proxy client 95. The user 78f typically does not include an ASP access module 338, because no such module is required to facilitate interaction between the user 78f and the application server 89.

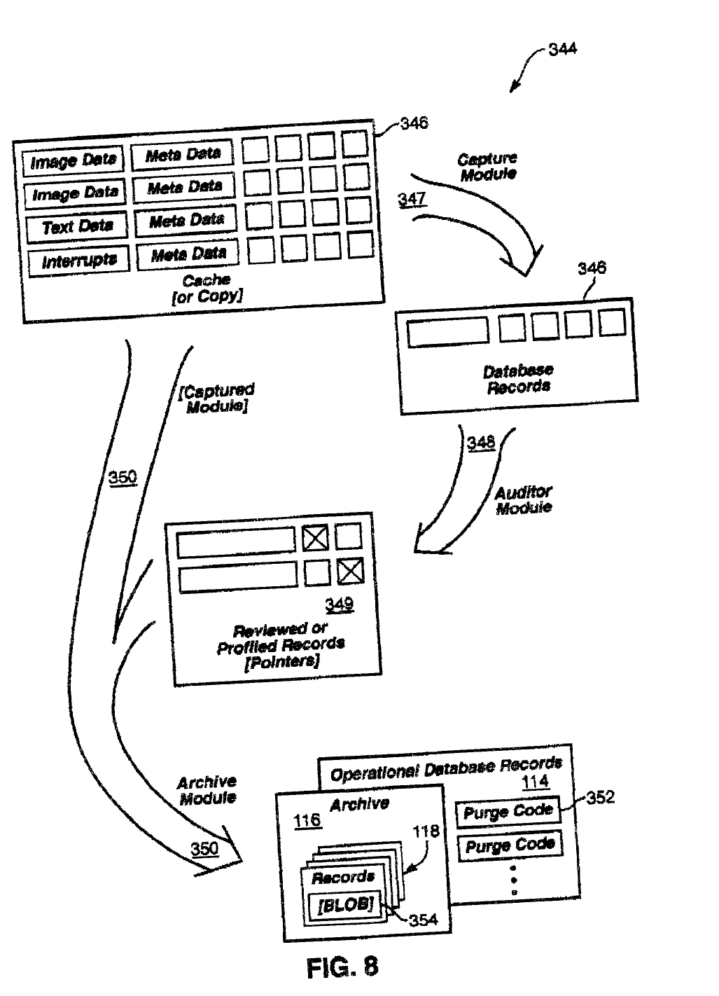

Referring to FIG. 8, a process 344 may take records from a cache 346 and place them in an operational database 114. Eventually, the content of the cache 346, or an appropriate portion thereof may be archived in an archive 116. In certain selected embodiments, the capture module 108 may capture 347 the contents of the cache 346, creating a database record 114. The auditor module 130 may then audit 348 the database record 114, by use of human intervention, or automatically, depending on content, and sophistication of the auditor module 130. Accordingly, the audit process 348 results in a reviewed record 349 or profile record 349. Alternatively, the record 349 may merely be embodied as a series of pointers 349 or indicators 349 associated with a database record 114 in order to determine the disposition of a database record 114.

An archive module 150, or a capture module 108 may be responsible to the archive 350. The content of a cache 346, or a reviewed record 349 as an archive record 118. Depending on whether copies or pointers are used, database record 114 and archive record 118, may be one in the same. That is, an archive record 118 may simply be a database record 114 having a purge code 352 that determines whether an when a database record 114 may be purged. In addition, certain access privileges may be restricted such that only authorized personnel may actually edit or delete a particular database record 114 that is determined to be part of an archive 116. Again, different architectures may be implemented depending on the sophistication of users, and the importance of maintaining independent or separate copies or records in an archive 116.

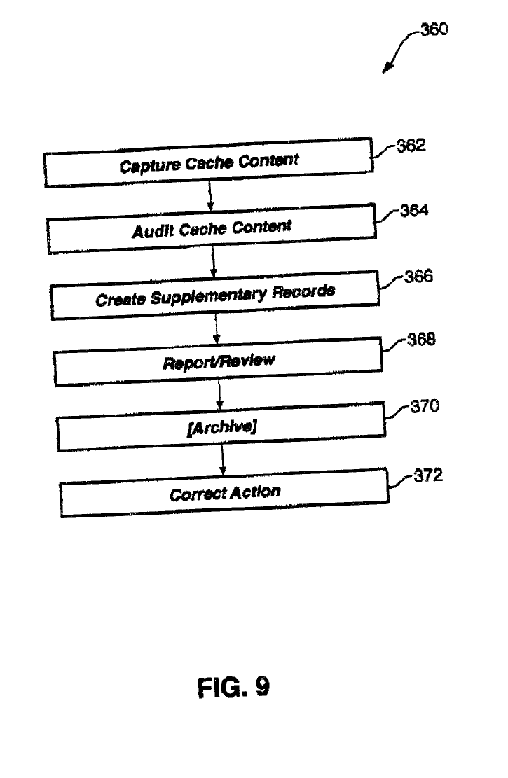

Referring to FIG. 9, one embodiment of a process 360 for the capture process 347 may include a capture step 362 in which the content of a cache 346 is copied or otherwise acquired. An audit step 364 may analyze or audit the cache content, after which a create step 366 creates a supplementary record. Supplementary records may be created, or identified, as discussed above, by making individual copies, or by marking records and rendering them inaccessible and indestructible to unauthorized persons.

Reporting 368 or reviewing 368 may be done in parallel or series. That is, reporting 368 may be embodied in providing alerts and reports to an authority responsible for receiving information about Internet access. Nevertheless, in some embodiments, a service module 80 may be hosted on an enterprise server at a company or at an audit facility, in which the only reporting is a periodic review 368 by one in authority.

An archives step 370 is optional. In some embodiments, a case may be created against a user. In other embodiments, a manager or parent may only be interested in taking some corrective action 372, which may include changing rules in rules 158. Thus, depending on the burden imposed by protocols of society or the law, archiving 370 may or may not be necessary.

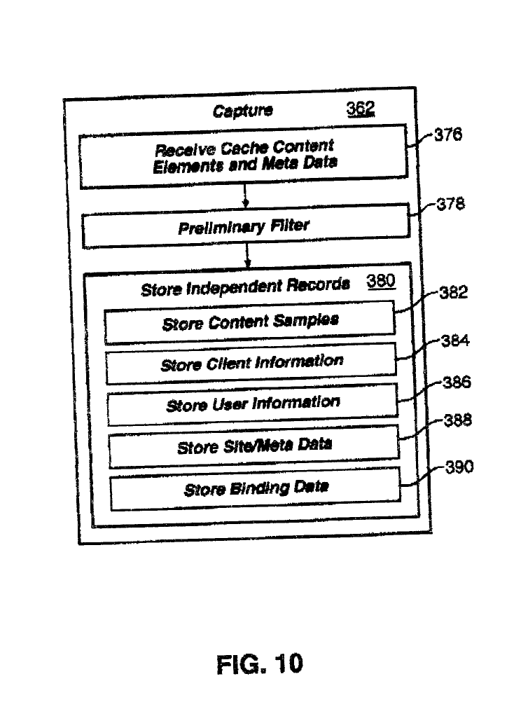

Referring to FIG. 10, the capture process 362 may include receiving 376 the content of a cache, or various elements stored in a cache 346. Thereafter, preliminary filtering 378 may determine the appropriateness or inappropriateness of the content received. A storage step 380 may store the independent records or mark them as appropriate. Accordingly, storing 382 content samples may include 100 percent of sampling. Alternatively, only selected samples, or samples that have been deemed inappropriate may be stored 382. Similarly, storing 384 client information may be executed before or after storing 382 of content. That is, client information 384 may already be available. Similarly, user information may also be available so storing 386 may be a matter of simply identifying or drawing on user information in the step 386. Storing 388 site data or meta data that identifies site access, times, and the like may be done individually or independently from the content storing 382.

If virtually every keystroke is recorded, then the storage 388 of meta data and site data will be a matter of streaming such data along with content to complete the storage 3 88 of such site and meta data and the storage 382 of content. Ultimately, storing 390 binding data may be a matter of establishing pointers for storing client information 384, user information 386, content information 382, and meta data 388. Numerous individual mechanisms may be implemented for completing all of the storage 380. Thus, the order, and the approach for storing 380 is not required to be in accordance with the illustrated architecture, in order to implement all embodiments of an apparatus and method in accordance with the invention.

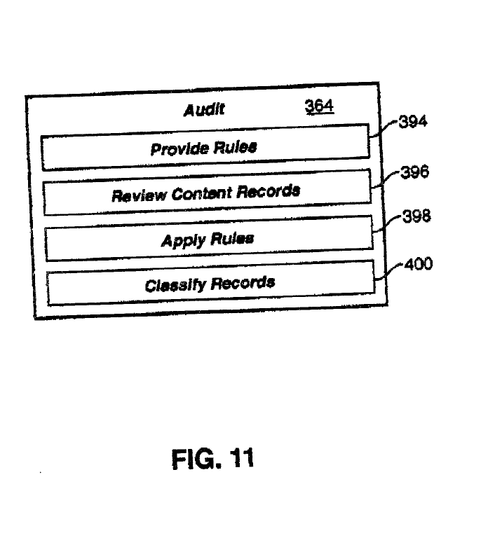

Referring to FIG. 11, auditing 364 may be implemented in a variety of steps, including numerous or few steps, depending on a particular view of the architecture. Primarily, auditing 364 may include providing 394 a set of rules by which auditing is to be completed. Providing rules 394 may also include a matter of providing policies that are governing the use of an individual computer 11. Capture having been effected, reviewing 396 the content of captured records is the next principal step in the auditing process 364. An auditor then, by applying the rules provided 398, may eventually then analyze 400 or classify 400 all records reviewed 396. Thereafter, reporting etc. as described above may provide the functional needs to applying corrective action.

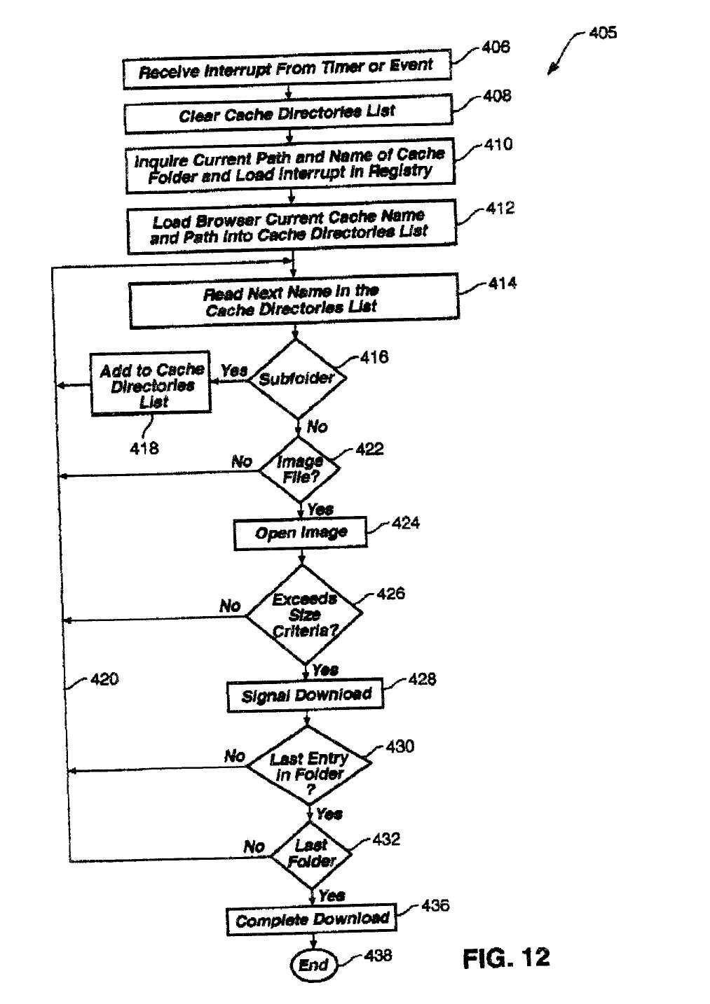

Referring to FIG. 12, a process 405 for accessing cache content may include receiving 406 an interrupt, a timer, trigger, or identification of an event. Accordingly, clearing a directories list 408 may remove clutter. Next, inquiring 410 for the current path and name of the main cache folder and loading that path and name into the cache directories list 412 of a browser on a computer 11. This associated path placed in the cache directories list provides the highest level cache directory accessed by the subject computer, at the current time.

Now that the highest level path(s) have been located and loaded into the cache directories list, reading 414 the next available name in the cache directories list provides the folder name or an object within the folder. A test 416 subsequently determines whether or not the name corresponds to a subfolder. If so, then the name of that subfolder is added 418 to the cache directories list, in order that it may be investigated later. If the test 416 results in a negative response, then a test 422 determines whether or not it is a the file, since the name did not correspond to a folder, is an image file. If the file name does not correspond to an image, then the process 405 returns 420 to the reading step 414. Other tests such as 416, 422 could be added at this point to test for other file types or attributes.

If the file name does correspond to an image file, then opening 424 that image provides additional evaluative opportunity. Accordingly, a test 426 determines whether or not the image size exceeds some predetermined criterion. The criterion typically reflects large images, such as viewed pictures, rather than small images corresponding to icons, emblems, symbols, borders, and the like corresponding to various administrative and graphical user interface details.

If the test 426 reveals a size corresponding to a very small image, then the process 405 returns 420 to the reading step 414 seeking the next file name. On the contrary, however, if the size criterion is met, then signaling 428 a download, copy or processing of the image then yields to a test 430. That is, an image is identified 428, signaled 428, copied 428, processed 428, stored 428, or downloaded 428 in order to be reviewed. The image will thus become the subject of auditing.

Ultimately, the test 430 must determine whether the image or file was the last file in that cache directory. If the file is not the last 420, then read the next name 414 is appropriate. However, if the file is the last, then a test 432 must determine whether the folder is the last folder in the cache. If other folders exist in the cache directories list, then the process 405 returns 420 to reading 414 the next name in the cache directories list. Otherwise, completing 436 the download or processing of all designated files is the only requirement before ending 438 the process 405.

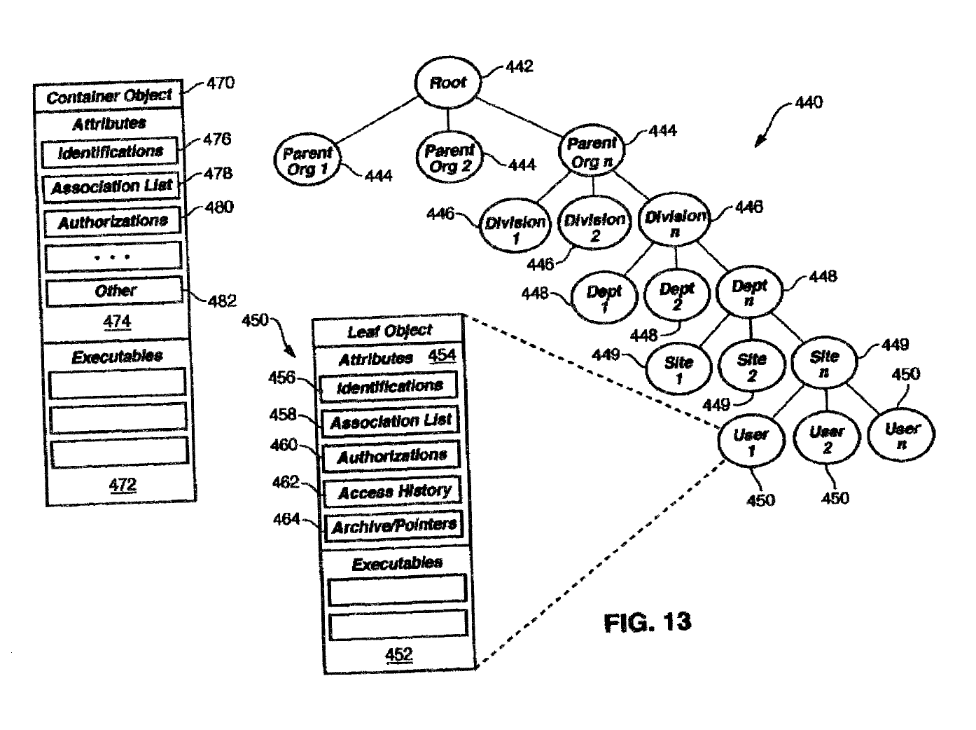

Referring to FIG. 13, one embodiment of an object oriented database 440 may include a root directory 442. The root directory 442 may be maintained by an application service provider, or the like. Accordingly, various container objects 444 may represent a parent organization. A parent organization may be a customer of the owner of the root directory 442. Alternatively, in a stand alone system in an enterprise, the root directory 442 may be maintained by the highest level of management or security in such an organization. Meanwhile, numerous layers of containers 446, 448, 449 may exist in a hierarchical arrangement. Ultimately, each hierarchical tree within the object oriented database 440 must terminate in leaf objects 450. Typically, leaf objects 450 correspond to individual users. In certain embodiments, leaf objects 450 may refer to individual physical locations, individual pieces of hardware, or any other entity that may be stored in a directory services type of object oriented database.

In general, a leaf object 450 may be represented by a data structure including executables 452 and attributes 454. Executables 452 are not necessary in every instance. Nevertheless, certain attributes 454 may be extremely useful in dealing with any particular entity represented by an object 450. For example, an identification 456, that is recognizable in some form, varying from the name of an individual person, to a serial number or other piece of equipment, to an inventory number, or a network identification number, or network address, or the like may uniquely identify a particular leaf object 450. Similarly, an association list 458 may be very useful. For example, other leaf objects 450 that have an association or other container objects 444 that have an association with a particular leaf object 450 may be identified in an association list 456 providing ties that are useful in navigating between objects. Similarly, in a particular entity 450 represented by a leaf object 450 may have certain authorizations 460 that are unique, or that are inherited from some parent container object 444-449.

Importantly, an access history 462 may be stored in a leaf object 450. Alternatively, the access history 462 may merely refer to finding data to identify access history in a database 114. Similarly, an archive 464, or pointers 464 identifying locations in an archive 116, may serve to identify information that has been retrieved through audits, tracking, o r the like. Tracking refers to the process of continuing to build a system of archive records 118 associated with a particular user, in order to document an appropriate access.

Similarly, a container object 470 may also include executables 472 and attributes 474. The executables 472 may be optional, but may embody any of the functionalities identified in the foregoing with respect to the service module 80. Similarly, the executables 452 may embody any or all of the functionality identified with the service module 80. Alternatively, such functionality may be remote from the objects 450,470. Nevertheless, regardless of the particular architectural scheme, attributes 474 may include identification 476 and an association list 478 associated with a container object 470. Similarly, authorizations 480 for a container object 470 may be unique to the container object 470 and the corresponding actual entity, or may be inherited in whole or in part by other child objects between a particular parent 444-449, and any other child object down to an ultimate leaf object 450. Various other attributes 482 may be provided as necessary or convenient in order to support operation of the service module 80.

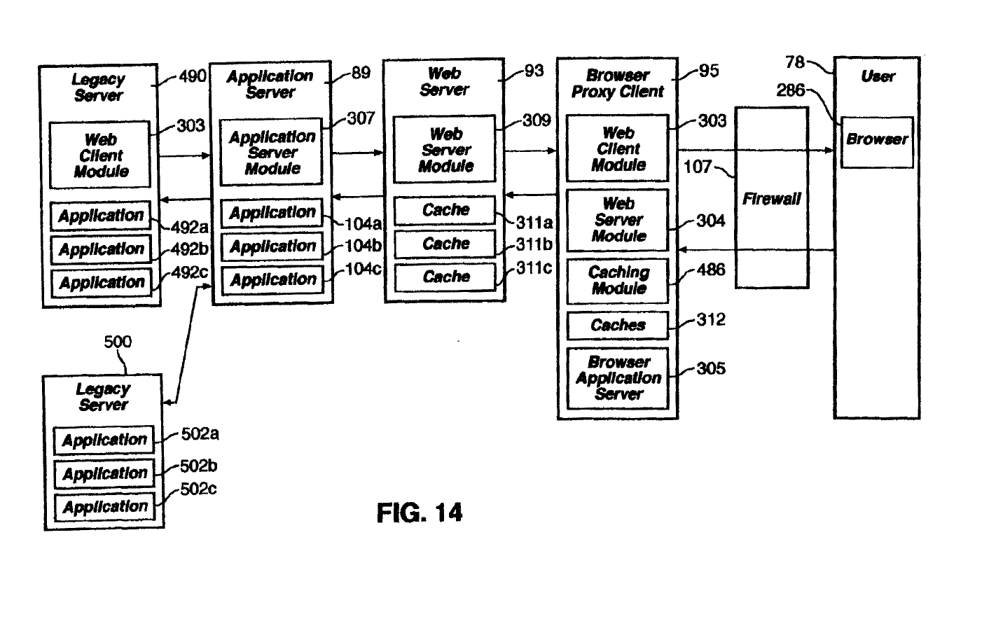

Referring to FIG. 14, a hardware and software architecture in accordance with the present invention may include an application server 89, a web server 93, and a browser proxy client 95. In the depicted embodiment, the application server 89 typically hosts one or more application server modules 307 that host application sessions on application server 89. The web server module 309 of the web server 93 may request application set information to enable the web server module 304 to format HTML pages for display in a browser served to any user 78 hosting a typical browser 286 for viewing in the browser. The web server 93 may host a variety of caches 311 a-c for storing files and other information. The user 78 may pass a request for the accessing of an application to the application server module 304, which request typically passes through the browser 286, to the browser application 305, to the web server module 304, to the web client module 303, and to the web server module 309.

As described hereinbefore, the web server module 309 typically facilitates communication between the user 78 and the application server module 307 of the application server 89. All of the execution of applications 104, which are depicted as applications 104a-c, occurs on application server 89; only required user interface communication and commands are passed between the user 78 and the application server 89.

The browser proxy client 95 may host the web client module 303, a web server module 304, a browser application 305, a set of caches 312, and a caching module 486. The caching module 486 may be a service module 80, which provide the functionalities of control, capture, auditing, reporting, and the like in accordance with the invention. Additionally, the caching module 486 may be any other software module or construct that functions to cache information and/or images from a data stream into caches, such as a caches 312.

An application 104a-c on the application server 89 typically responds to the user 78 by way of an application server module 307 to web server module 309, to web client module 303, to browser application 305, to web server module 304, and to user browser 286 of user 78.

The browser application 305 typically serves a browser to be displayed within a browser 286 on the user 78. Accordingly, the browser application 305 provides a browser displaying the application sets 104a-c, 502a-c, 492a-c within the browser 286 or plurality of browsers 286 for interaction with a user 78 or a plurality of users 78. Accordingly, the hardware and software architecture of FIG. 14 is capable of publishing applications to many users 78 via browsers 286 substantially simultaneously in a one to many relationship. In other words, the depicted embodiment can serve applications to users 78 without the installation of any “bit set” in addition to the browser 286 on user 78. The functionality of the web client module 303, the application server module 307, and the web server module 309 may be provided by Citrix™ Nfuse™ application software.

Continuing to refer to FIG. 14 while also referring to FIG. 7, an architecture in accordance with the invention may also include a legacy server 490 and a legacy server 500. An application server 490 may be a web-enabled server capable of hosting a web server module 304 or non-web-enabled server hosting a web client module 303 that also hosts applications 492a-c that are not capable of being served by web server 309, as described hereinabove. The legacy server 490 may host a web client module 303 or other equivalent software construct, which may communicate with the application server 89 using the ICA or like protocol. The applications 492a-c may be executed in application sessions on the legacy server 490, and the user interface information from the execution of the applications 492a-c may be communicated from the web client module 303 via the application server 89, the web server 93 and the browser proxy client 95 to the browser 286 on the user 78. In like manner, the user 78 may send requests back to the executing application 492a-c on the legacy server 490.

A legacy server 500 may be a non-web-enabled server not capable of hosting a web client module 303 but hosts applications 502a-c that are not capable of being served by an application server module 307, as described hereinabove. Such a legacy server 500 could, however, be connected to an application server 89 via a variety of known network communications mechanisms, known in the art, including without limitation TCP/IP, Telnet, ASDC, TTY, and IPX/SPX. The applications 502a-c may be executed in application sessions on the legacy server 500, and the user interface information from the execution of the applications 502a-c may be communicated via one of the above-described network communications mechanisms from the legacy server 500 to the application server 89, to the web server 93, and to the browser proxy client 95, which serves as interface to the browser 286 on the user 78. In like manner, the user 78 may send requests back to the executing application 502a-c on the legacy server 500.

Secure Sockets Layer (SSL) is a leading security protocol used to provide secure communications over the Internet 72. Typically, under the SSL protocol, a secure communication is encrypted at the originating network server and remains encrypted until arrival at the ultimate user receiving the communication, providing what may be called an unbroken SSL chain.

Referring to FIG. 7 while continuing to refer to FIG. 14, under the SSL protocol, encryption might occur at servers 294, 300, and 302, while decryption might occur at users 78a-f, thus providing an unbroken SSL chain between server and user. Without an appropriate decryption key, a communication typically cannot be read at points along the network path between the originating network server and the ultimate user. Referring to FIG. 14 and in view of the foregoing, a caching module 486, such as a service module 80, hosted at points along the communication path between the originating network server and the ultimate user cannot typically perform the functions of control, capture, auditing, reporting, and the like without access to an appropriate decryption key, because content cannot be read and cached.

The architecture depicted in FIG. 14, however, provides a mechanism whereby the SSL chain may be terminated behind the firewall 107 to provide a “gap”, giving the caching module 486 the opportunity to read and cache secure communication content. As known by those skilled in the art, the SSL chain typically starts at application server module 307 and ends directly on browser 286 of a user 78. Accordingly, the SSL chain may be established at proxy client 95, in conjunction with the caching module 486, in order to read and cache the content of communications to caches 312. The communications may then be encrypted using the SSL protocol or other appropriate protocol for secure transmission by the browser proxy client 95 across the firewall 107 for display in the browser 286 on the user 78.

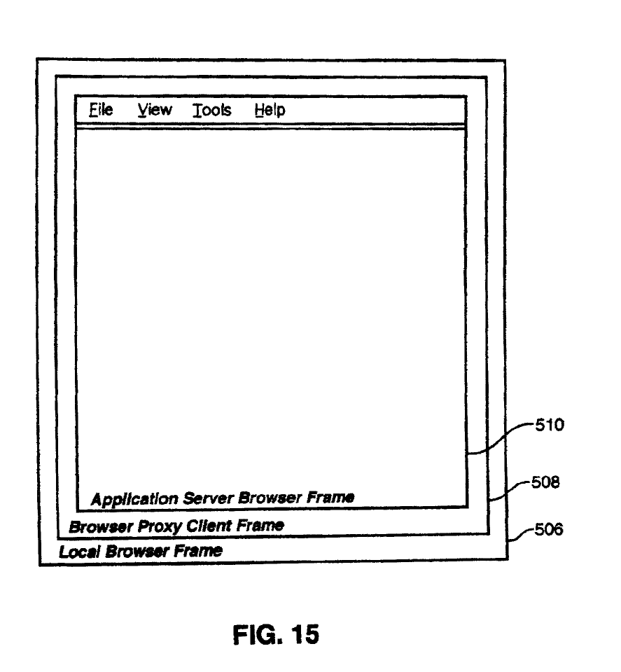

Referring to FIG. 15 while continuing to refer to FIG. 14, the architecture of FIG. 14 typically results in output to the computer screen of a user 78 having the arrangement of frames 506, 508, 510, as shown in FIG. 15. The local browser frame 506 corresponding to the local browser 286 executing on the user 78 displays as the outermost frame of the output to the computer screen. Within the frame 506, a browser proxy client frame 508 displays, which corresponds to the browser served to the user 78 by the browser application 305. Within the frame 508, an application server browser frame 510 displays corresponding to the user interface of the application session executing on the web server 93 through web server module 309.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. An apparatus for serving applications, the apparatus comprising:
a processor, for executing executable data structures;
a memory device operably connected to the processor for storing the executable data structures and associated operational data structures, the executable and operational data structures comprising:
an application server configured to host an application session;
a web server in operable communication with the application server and configured to communicate data corresponding to a user interface of the application session;
a browser proxy client in operable communication with the web server and configured to publish the data to a plurality of browsers.

2. The apparatus of claim 1, wherein the browser proxy client further comprises a caching module configured to selectively capture the data.

3. The apparatus of claim 2, wherein the caching module is a capture module, configured to selectively capture data reflecting computer usage corresponding to a user of the plurality of users and to render the captured data inaccessible to the corresponding user.

4. The apparatus of claim 3, wherein the browser proxy client further comprises a reporting module configured to present to a reviewing authority the captured data.

5. The apparatus of claim 4, wherein the browser proxy client further comprises an audit module configured to provide to an independent agent the captured data for audit.

6. The apparatus of claim 2, wherein the browser proxy client further comprises a web client in operable communication with the application server and configured to communicate data to the web client.

7. The apparatus of claim 6, wherein the browser proxy client further comprises a browser application for serving a second browser for display within the first browser.

8. The apparatus of claim 1, further comprising a legacy server in operable communication with the application server and configured to host a legacy application session thereon.

9. The apparatus of claim 8, further comprising a web client configured to communicate data corresponding to a user interface of the legacy application session to the application server.

10. The apparatus of claim 8, further comprising a data link in operable communication with the legacy server and the application server, and configured to communicate.

11. A method for serving applications, the method comprising:
providing an application server configured to host an application session;
providing a web server in operable communication with the application server and configured to communicate data corresponding to a user interface of the application session;
providing a browser proxy client in operable communication with the web server and configured to publish the data to a plurality of browsers for use by a plurality of users;
hosting an application session requested by a user of the plurality of users; and
communicating data from the application session for publication in a browser of the plurality of browsers.

12. The method of claim 11, further comprising capturing data corresponding to the application session; and rendering the captured data inaccessible to the corresponding user.

13. The method of claim 12, further comprising reporting selected computer usage data to a reviewing authority.

14. The method of claim 13, further comprising auditing the data corresponding to the application session.

15. The method of claim 11, wherein the browser proxy client further comprises a caching module configured to selectively capture the data.

16. The method of claim 11, wherein the browser proxy client further comprises a web client in operable communication with the application server and configured to communicate data to the web client.

17. The method of claim 16, wherein the browser proxy client further comprises a browser application for serving a second browser for display within the first browser.

18. The method of claim 11, further comprising a legacy server in operable communication with the application server and configured to host a legacy application session thereon.

19. The method of claim 18, further comprising a web client configured to communicate data corresponding to a user interface of the legacy application session to the application server.

20. The method of claim 18, further comprising a data link in operable communication with the legacy server and the application server, and configured to communicate.
